(19) United States
(12) Patent Application Publication
(10) Pub. No.: US 2026/0017829 A1
(43) Pub. Date: Jan. 15, 2026

(54) HYPOTHETICAL REFERENCE DECODING OPERATION FOR BASEMESH BITSTREAMS

(71) Applicants: SONY GROUP CORPORATION, Tokyo (JP); Sony Corporation of America, New York, NY (US)

(72) Inventors: Danillo Graziosi, Flagstaff, AZ (US); Ali Tabatabai, Cupertino, CA (US)

(21) Appl. No.: 19/193,731

(22) Filed: Apr. 29, 2025

Related U.S. Application Data
(60) Provisional application No. 63/669,530, filed on Jul. 10, 2024.

(51) Int. Cl. G06T 9/00

(52) U.S. Cl. CPC G06T 9/00

(57) ABSTRACT

A Hypothetical Reference Decoding (HRD) operation for basemesh bitstreams is described herein. An HRD model is able to handle and address the peculiarities associated with the decoding process, and provisioning of appropriate HRD related syntax structures and tables in the Video Usability information (VUI) as well as buffering period, basemesh timing, and decoding unit information Supplemental Enhancement Information (SEI) messages.

### CROSS-REFERENCE TO RELATED APPLICATION(S)

This application claims priority under 35 U.S.C. § 119(e) of the U.S. Provisional Patent Application Ser. No. 63/669,530, filed Jul. 10, 2024 and titled, “HYPOTHETICAL REFERENCE DECODING OPERATION FOR BASEMESH BITSTREAMS,” which is hereby incorporated by reference in its entirety for all purposes.

### FIELD OF THE INVENTION

The present invention relates to basemesh bitstreams. More specifically, the present invention relates to decoding basemesh bitstreams.

### BACKGROUND OF THE INVENTION

In the new international dynamic mesh compression standard (ISO/IEC 23090-29), a dynamic sequence bitstream is composed of several sub-bitstreams, a basemesh sub-bitstream being one of them. This sub-bitstream contains a sequence of possibly low resolution meshes, that will be later subdivided and combined with other sub-bitstreams to reconstruct the original dynamic mesh sequence. The basemesh sub-bitstream is a sequence of NAL units that contains INTRA encoded meshes and INTER/SKIP encoded meshes. In order to process incoming NAL units and realize the INTER/SKIP encoding, the codec stores coded NAL units and reference reconstructed meshes, which involves the management of internal buffers (a Coded BaseMesh Buffer, or CBMB, and a Decoded BaseMesh Buffer, or DBMB). Since the processing of NAL units is done by calling external entities (for instance, the MEB codec for the static mesh part, and an embedded motion codec for the motion part), the HRD model used for video sequences may not apply to the basemesh sub-bitstream.

### SUMMARY OF THE INVENTION

A Hypothetical Reference Decoding (HRD) operation for basemesh bitstreams is described herein. An HRD model is able to handle and address the peculiarities associated with the decoding process, and provisioning of appropriate HRD related syntax structures and tables in the Video Usability information (VUI) as well as buffering period, basemesh timing, and decoding unit information Supplemental Enhancement Information (SEI) messages.

In one aspect, a method programmed in a non-transitory memory of a device comprises receiving a basemesh bitstream, decoding, using a basemesh buffer, the basemesh bitstream into a mesh comprising vertex information and connectivity information. The method further comprises parsing the basemesh bitstream into a parsed basemesh bitstream, decoding the parsed basemesh bitstream into a decoded submesh which includes submesh data and a submesh header, extracting data from the submesh data, performing intra submesh processing, performing inter submesh processing and performing skip submesh processing. The basemesh buffer is configured for storing the decoded submesh and additional mesh information. The additional mesh information comprises: duplicate vertex coordinate information, vertex neighbor count information and vertex neighbor information. Decoding the basemesh bitstream is implemented without utilizing internal buffering. The basemesh bitstream is divided into a plurality of submeshes which are decoded independently. A reference mesh of the basemesh bitstream and the mesh have a same number of attributes, connectivity and vertices.

In another aspect, an apparatus comprises a non-transitory memory for storing an application, the application for: receiving a basemesh bitstream, decoding, using a basemesh buffer, the basemesh bitstream into a mesh comprising vertex information and connectivity information and a processor coupled to the memory, the processor for processing the application. The application is further configured for: parsing the basemesh bitstream into a parsed basemesh bitstream, decoding the parsed basemesh bitstream into a decoded submesh which includes submesh data and a submesh header, extracting data from the submesh data, performing intra submesh processing, performing inter submesh processing and performing skip submesh processing. The basemesh buffer is configured for storing the decoded submesh and additional mesh information. The additional mesh information comprises: duplicate vertex coordinate information, vertex neighbor count information and vertex neighbor information. Decoding the basemesh bitstream is implemented without utilizing internal buffering. The basemesh bitstream is divided into a plurality of submeshes which are decoded independently. A reference mesh of the basemesh bitstream and the mesh have a same number of attributes, connectivity and vertices.

In another aspect, a system comprises an encoder configured for encoding a basemesh bitstream and a decoder configured for: receiving the basemesh bitstream, decoding, using a basemesh buffer, the basemesh bitstream into a mesh comprising vertex information and connectivity information. The decoder is further configured for: parsing the basemesh bitstream into a parsed basemesh bitstream, decoding the parsed basemesh bitstream into a decoded submesh which includes submesh data and a submesh header, extracting data from the submesh data, performing intra submesh processing, performing inter submesh processing and performing skip submesh processing. The basemesh buffer is configured for storing the decoded submesh and additional mesh information. The additional mesh information comprises: duplicate vertex coordinate information, vertex neighbor count information and vertex neighbor information. Decoding the basemesh bitstream is implemented without utilizing internal buffering. The basemesh bitstream is divided into a plurality of submeshes which are decoded independently. A reference mesh of the basemesh bitstream and the mesh have a same number of attributes, connectivity and vertices.

### BRIEF DESCRIPTION OF THE DRAWINGS

FIG. 1 shows a diagram of a first option for single decoder conceptualization according to some embodiments.

FIG. 2 shows a diagram of a second option for single decoder conceptualization according to some embodiments.

FIG. 3 shows a diagram of a third option for single decoder conceptualization according to some embodiments.

FIG. 4 shows a diagram of a fourth option for single decoder conceptualization according to some embodiments.

FIG. 5 shows a diagram of an example of the CBMB fullness and the extraction of bits from the received and stored bitstream according to some embodiments.

FIG. 6 shows a structure of BNAL unit streams for HRD conformance checks according to some embodiments.

FIG. 7 shows a basemesh HRD buffer model according to some embodiments.

FIG. 8 shows a block diagram of an exemplary computing device configured to implement the basemesh decoder according to some embodiments.

### DETAILED DESCRIPTION OF THE PREFERRED EMBODIMENT

A Hypothetical Reference Decoding (HRD) operation for basemesh bitstreams is described herein. A model to unify the embedded codecs and allow the basemesh bitstream to have a single buffering management system is described, making the architecture closer to what is used in video decoders, so that many of the video encoding concepts recently developed are able to be used for the basemesh. Furthermore, an HRD concept that operates on submeshes, an independently decodable unit of a basemesh, is described.

In annex H of H.264/AVC, the decoding process is performed separately. That is the use of a static decoder for intra coded Bitstream Management Control Layer (BMCL) Network Abstraction Layer (NAL) units and a motion decoder for inter coded BMCL NAL units. This is unlike the traditional decoding process, such as High Efficiency Video Coding (HEVC), in which the decoding of either intra or inter Video Coding Layer (VCL) NAL units is performed within a single decoder framework. Described herein are options for the conceptualization of a single decoder notion to address and deal with the annex H decoding process.

The high-level abstraction into a single decoder notion will, in turn, allow the use of the legacy HRD model. The options that can be used for the proposed single decoder abstraction are described.

### Conceptualization to Single Decoder Notion

Described herein are options for single decoder conceptualization, at basemesh level. An important concept, in these options, is the demarcation of the processes performed by the basemesh, motion and static decoders. The single decoder is conceptualized through the introduction of a single Coded BaseMesh Buffer (CBMB) and Decoded BaseMesh Buffer (DBMB) at basemesh level, as shown in the Figures.

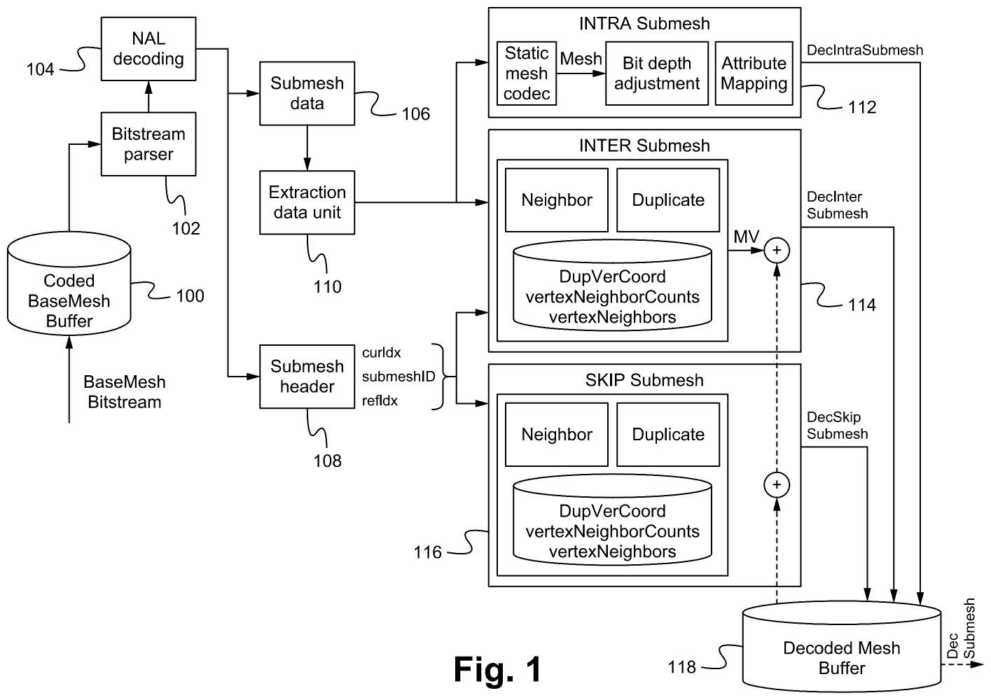

FIG. 1 shows a diagram of a first option for single decoder conceptualization according to some embodiments.

In the step 100, a coded basemesh buffer receives a basemesh bitstream (e.g., encoded bitstream). In the step 102, the basemesh bitstream is parsed using a bitstream parser. In the step 104, the basemesh bitstream is decoded using an NAL decoder. Additionally, steps to extract submesh data, in the step 106 and extract the submesh header, in the step 108 are implemented. Data is extracted from the submesh data, in the step 110. Further processing occurs, including intra submesh processing, in the step 112, inter submesh processing, in the step 114, and skip submesh processing, in the step 116, to reconstruct the mesh with vertices, connectivity and other information. In the step 118, the reconstructed mesh information is stored in a decoded basemesh buffer. The decoded basemesh buffer is able to be used for prediction (e.g., by re-using decoded pictures).

In some embodiments, fewer or additional steps are implemented. In some embodiments, the order of the steps is modified.

In this option, the following specific processes are performed by basemesh, static and motion decoders. As described, the processes performed by the basemesh include: bitstream parsing according to clauses H.7, H.8 and H.10; BNAL decoding according to subclause H.9.3; extraction of submesh header according to subclause H.9.4 to obtain variables curIdx, submeshID and refIdx; extraction of submesh data and demultiplexing of extracted data into intra and inter-related data for static and motion decoders, according to subclause H.9.4.5.1; performing the processes of bit depth adjustment, attribute mapping and storage of decoded intra submesh into DBMB according to subclause H.9.4.5.2; the extraction of the reconstructed and stored reference basemesh and incorporation with the decoded motion vectors from motion decoder to reconstruct and store the decoded inter basemesh into DBMB, according to subclause H.9.4.5.3; and the extraction and copying of the reconstructed and stored reference basemesh to reconstruct and store the decoded inter basemesh into DBMB, according to subclause H.9.4.5.4.

The processes performed by the motion decoder include: generating output motion vectors but with local buffers for duplicate and vertex neighbor table calculation, according to subclauses H.9.4.5.3.2 and H.9.4.5.3.3.

The processes performed by the static decoder include decoding and generation of basemesh.

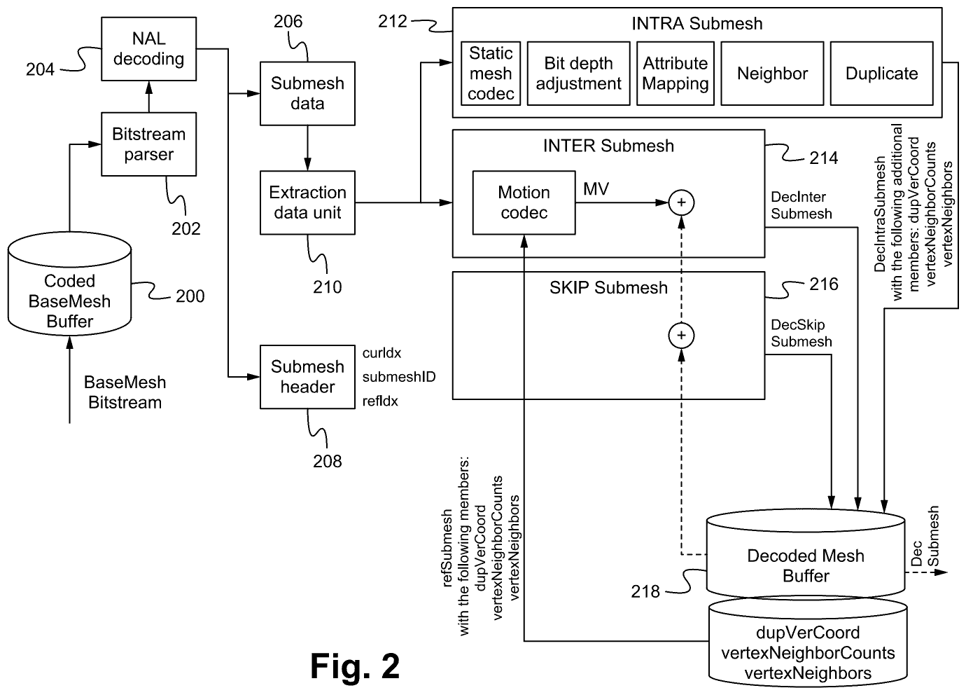

FIG. 2 shows a diagram of a second option for single decoder conceptualization according to some embodiments.

In the step 200, a coded basemesh buffer receives a basemesh bitstream (e.g., encoded bitstream). In the step 202, the basemesh bitstream is parsed using a bitstream parser. In the step 204, the basemesh bitstream is decoded using an NAL decoder. Additionally, steps to extract submesh data, in the step 206 and extract the submesh header, in the step 208 are implemented. Data is extracted from the submesh data, in the step 210. Further processing occurs, including intra submesh processing, in the step 212, inter submesh processing, in the step 214, and skip submesh processing, in the step 216, to reconstruct the mesh with vertices, connectivity and other information. In the step 218, the reconstructed mesh information is stored in a decoded basemesh buffer. The decoded basemesh buffer is able to be used for prediction (e.g., by re-using decoded pictures).

In some embodiments, fewer or additional steps are implemented. In some embodiments, the order of the steps is modified.

The general flow of the second option is similar to that of the first option. However, the buffer is removed from inside the motion decoder. Additionally, other functions and structures have been removed such as neighbor calculations and duplicate list calculations. The functions and structures have been moved inside the basemesh framework. Additionally, the decoded submesh with additional information (e.g., dupVerCoord, vertexNeighborCounts, and vertexNeighbors) is stored inside the decoded basemesh buffer. When implementing the motion decoder, the additional information is passed on to the motion decoder, so the motion decoder does not store the data, since the data is stored outside the motion decoder, such that the motion decoder is able to focus on decoding the bitstream and providing the results. This results in instantaneous motion decoding by receiving the input and obtaining the output. The static mesh decoder functions similarly, which is an instantaneous decoder. There is no local, internal buffering in this implementation.

In the second option, the processes performed by the basemesh include: bitstream parsing according to clauses H.7, H.8 and H.10; BNAL decoding according to subclause H.9.3; extraction of submesh header according to subclause H.9.4 to obtain variables curIdx, submeshID and refIdx; extraction of submesh data and demultiplexing of extracted data into intra and inter-related data for static and motion decoders, according to subclause H.9.4.5.1; performing the processes of bit depth adjustment, attribute mapping and storage of decoded intra submesh into DBMB according to subclause H.9.4.5.2; the extraction of the reconstructed and stored reference basemesh and incorporation with the decoded motion vectors from motion decoder to reconstruct and store the decoded inter basemesh into DBMB, according to subclause H.9.4.5.3; the extraction and copying of the reconstructed and stored reference basemesh to reconstruct and store the decoded inter basemesh into DBMB, according to subclause H.9.4.5.4; and local buffers for duplicate and vertex neighbor table calculation, according to subclauses H.9.4.5.3.2 and H.9.4.5.3.3.

The processes performed by the motion decoder include decoding and generating output motion vectors.

The processes performed by the motion decoder include decoding and generation of basemesh.

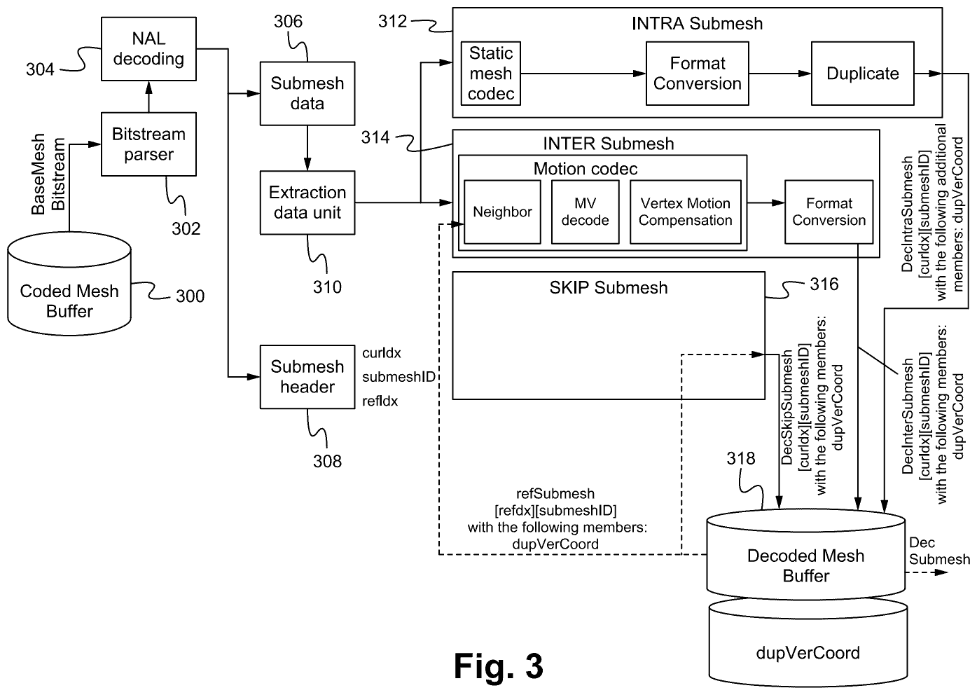

FIG. 3 shows a diagram of a third option for single decoder conceptualization according to some embodiments.

In the step 300, a coded mesh buffer sends a basemesh bitstream (e.g., encoded bitstream) to a bitstream parser. In the step 302, the basemesh bitstream is parsed using the bitstream parser. In the step 304, the basemesh bitstream is decoded using an NAL decoder. Additionally, steps to extract submesh data, in the step 306 and extract the submesh header, in the step 308 are implemented. Data is extracted from the submesh data, in the step 310. Further processing occurs, including intra submesh processing, in the step 312, inter submesh processing, in the step 314, and skip submesh processing, in the step 316, to reconstruct the mesh with vertices, connectivity and other information. In the step 318, the reconstructed mesh information is stored in a decoded basemesh buffer. The decoded basemesh buffer is able to be used for prediction (e.g., by re-using decoded pictures).

In some embodiments, fewer or additional steps are implemented. In some embodiments, the order of the steps is modified.

The third option implements neighbor calculations, motion vector decoding and vertex motion compensation in the inter submesh processing, which improves efficiency in terms of decoding timing.

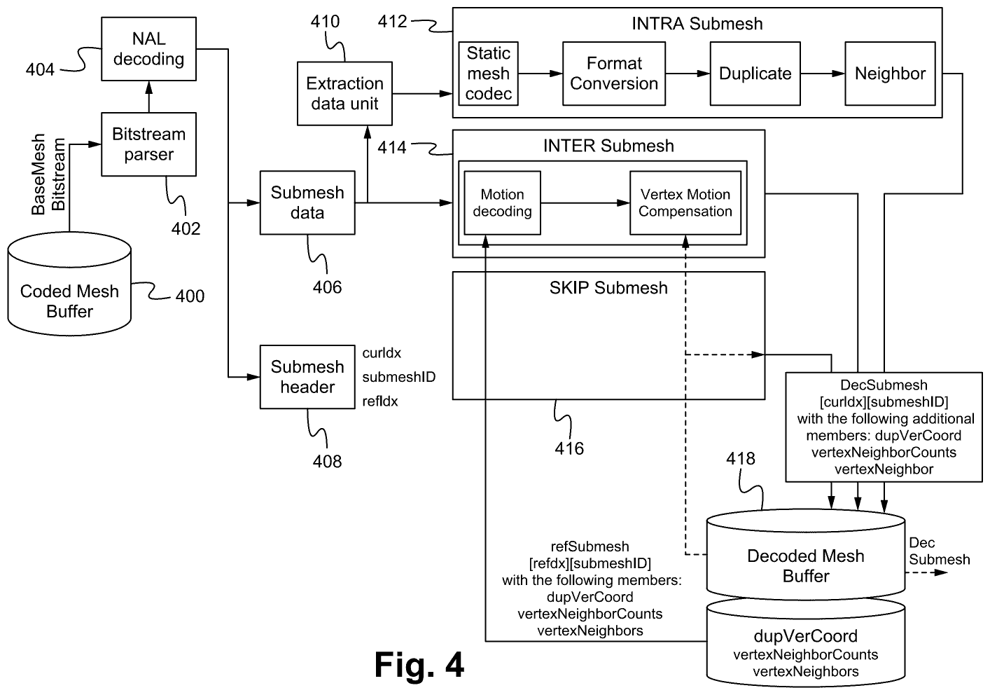

FIG. 4 shows a diagram of a fourth option for single decoder conceptualization according to some embodiments.

In the step 400, a coded basemesh buffer receives a basemesh bitstream (e.g., encoded bitstream). In the step 402, the basemesh bitstream is parsed using a bitstream parser. In the step 404, the basemesh bitstream is decoded using an NAL decoder. Additionally, steps to extract submesh data, in the step 406 and extract the submesh header, in the step 408 are implemented. Data is extracted from the submesh data, in the step 410. Further processing occurs, including intra submesh processing, in the step 412, inter submesh processing, in the step 414, and skip submesh processing, in the step 416, to reconstruct the mesh with vertices, connectivity and other information. In the step 418, the reconstructed mesh information is stored in a decoded basemesh buffer. The decoded basemesh buffer is able to be used for prediction (e.g., by re-using decoded pictures).

In some embodiments, fewer or additional steps are implemented. In some embodiments, the order of the steps is modified.

In the fourth option, the motion codec is removed from the inter submesh processing, and the motion decoding is part of the basemesh level of processing.

### HRD Operation Model

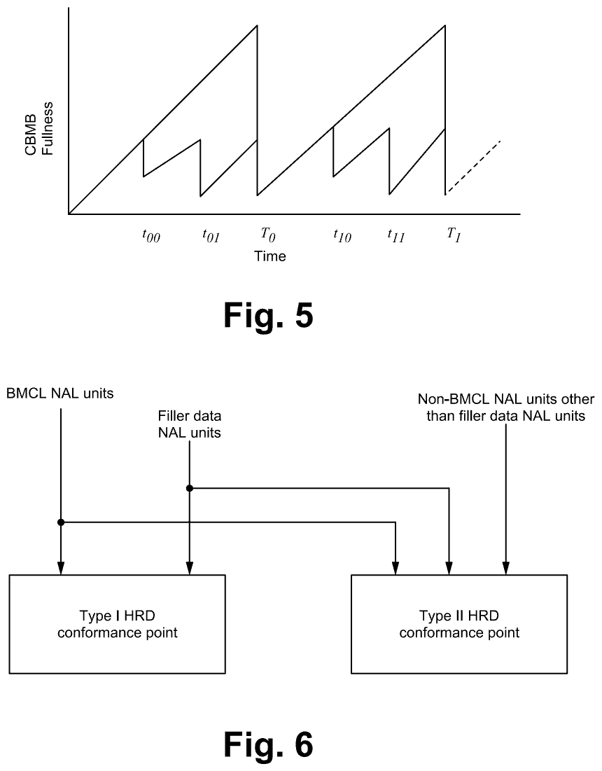

FIG. 5 shows a diagram of an example of the CBMB fullness and the extraction of bits from the received and stored bitstream according to some embodiments. In the example, each basemesh is segmented into three submeshes and the HRD parameters, tᵢ₁ indicates the CBMB removal time of submesh j, associated with basemesh i, and Tᵢ corresponds to removal time of basemesh i.

It is the decoder decision as to whether to use the basemesh-based HRD operation or submesh-based HRD operation which is indicated by the sub_mesh_hrd_params_present_flag syntax element. The syntax tables and structures are shown together with their associated semantics that are used for HRD operation. These include VUI parameters, buffering period, basemesh timing and decoding unit information SEI messages.

The current software does not support decoding of submeshes. First, it decodes all the frames associated with each submesh as opposed to decoding all the submeshes associated with a single frame first.

### HRD Related Syntax Tables and Structures

### General Basemesh Sequence Parameter Set RBSP Syntax

| | Descriptor |
|---|---|
| bmesh_sequence_parameter_set_rbsp( ) { | |
| bmsps_sequence_parameter_set_id | u(4) |
| bmesh_profile_tier_level( ) | |
| bmsps_intra_mesh_codec_id | u(8) |
| bmsps_inter_mesh_codec_id | u(8) |
| bmsps_geometry_3d_bit_depth_minus1 | u(5) |
| bmsps_inter_mesh_max_num_mvp_cand_minus1 | u(2) |
| bmsps_mesh_attribute_count | u(7) |
| for( i = 0; i < bmsps_mesh_attribute_count; i++ ) { | |
| bmsps_mesh_attribute_index[ i ] | u(8) |
| bmsps_mesh_attribute_type_id[ i ] | u(4) |
| bmsps_mesh_attribute_dimension_minus1[ i ] | u(6) |
| bmsps_attribute_bit_depth_minus1[ i ] | u(5) |
| bmsps_attribute_msb_align_flag[ i ] | u(1) |
| } | |
| bmsps_intra_mesh_post_reindex_method | ue(v) |
| bmsps_log2_max_mesh_frame_order_cnt_lsb_minus4 | ue(v) |
| bmsps_max_dec_mesh_frame_buffering_minus1 | ue(v) |
| bmsps_max_num_reorder_frames | ue(v) |
| bmsps_max_latency_increase_plus1 | ue(v) |
| bmsps_long_term_ref_mesh_frames_flag | u(1) |
| bmsps_num_ref_mesh_frame_lists_in_bmsps | ue(v) |
| for( i = 0; i < bmsps_num_ref_mesh_frame_lists_in_bmsps; i++ ) | |
| bmesh_ref_list_struct( i ) | |
| bmsps_inter_mesh_motion_group_size_minus1 | ue(v) |
| bmsps_inter_mesh_max_num_neighbours_minus1 | u(3) |
| bmsps_codec_specific_parameters_present_flag | u(1) |
| if( bmsps_codec_specific_parameters_present_flag ) { | |
| bmsps_mesh_codec_prefix_length_minus1 | u(8) |
| for( i = 0 ; i < bmsps_mesh_codec_prefix_length_minus1 + 1; i++ ) { | |
| bmsps_mesh_codec_prefix_data_byte[ i ] | u(8) |
| } | |
| } | |
| bmsps_vui_parameters_present_flag | u(1) |
| if(bmsps_vui_parameters_present_flag ) | |
| vui_paramaters( ) | |
| bmsps_extension_present_flag | u(1) |
| if( bmsps_extension_present_flag ) { | |
| bmsps_extension_count | u(8) |
| } | |
| if( bmsps_extension_count ){ | |
| bmsps_extensions_length_minus1 | ue(v) |
| for( i = 0; i < bmsps_extension_count; i++ ) { | |
| bmsps_extension_type[ i ] | u(8) |
| bmsps_extension_length[ i ] | u(16) |
| bmsps_extension( bmsps_extension_type[ i ], bmsps_extension_length[ i ] ) | |
| } | |
| } | |
| rbsp_trailing_bits( ) | |
| } | |

### VUI Parameters Syntax

| | Descriptor |
|---|---|
| vui_parameters( ) { | |
| vui_timing_info_present_flag | u(1) |
| if( vui_timing_info_present_flag ) { | |
| vui_num_units_in_tick | u(32) |
| vui_time_scale | u(32) |
| vui_mfoc_proportional_to_timing_flag | u(1) |
| if( vui_mfoc_proportional_to_timing_flag ) | |
| vui_num_ticks_mfoc_diff_one_minus1 | ue(v) |
| vui_hrd_parameters_present_flag | u(1) |
| if( vui_hrd_parameters_present_flag ) | |
| hrd_parameters( 1, 0 ) | |
| } | |
| } | |

### HRD Parameters Syntax

| | Descriptor |
|---|---|
| hrd_parameters( commonInfPresentFlag, maxNumSubLayersMinus1 ) { | |
| if( commonInfPresentFlag ) { | |
| bmnal_hrd_parameters_present_flag | u(1) |
| bmcl_hrd_parameters_present_flag | u(1) |
| if( bmnal_hrd_parameters_present_flag \|\| bmcl_hrd_parameters_present_flag ) { | |
| sub_mesh_hrd_present_flag | u(1) |
| if( sub_mesh_hrd_params_present_flag) | |
| tick_divisor_minus2 | u(8) |
| du_cbmb_removal_delay_increment_length_minus1 | u(5) |
| sub_mesh_cbmb_params_in_bm_timing_sei_flag | u(1) |
| dbmb_output_du_length_minus1 | u(5) |
| } | |
| bit_rate_scale | u(4) |
| cbmc_size_scale | u(4) |
| if(sub_mesh_hrd_params_present_flag) | |
| cbmb_size_du_scale | u(4) |
| initial_cbmb_removal_delay_length_minus1 | u(5) |
| au_cbmb_removal_delay_length_minus1 | u(5) |
| dbmb_output_delay_length_minus1 | u(5) |
| } | |
| } | |
| for( i = 0; i <= maxNumSubLayersMinus1; i++ ) { | |
| hrd_fixed_basemesh_rate_general_flag[ i ] | u(1) |
| if( !hrd_fixed_basemesh_rate_general_flag[ i ] ) | |
| hrd_fixed_basemesh_rate_within_cbms_flag[ i ] | u(1) |
| if( hrd_fixed_basemesh_rate_within_cas_flag[ i ] ) { | |
| hrd_elemental_duration_in_tc_minus1[ i ] | ue(v) |
| else | |
| low_delay_hrd_flag[ i ] | u(1) |
| if( !low_delay_hrd_flag[ i ] ) | |
| hrd_cbmb_cnt_minus1[ i ] | ue(v) |
| if( hrd_bmnal_parameters_present_flag ) | |
| hrd_sub_layer_parameters( i ) | |
| if( hrd_bmcl_parameters_present_flag ) | |
| hrd_sub_layer_parameters( i ) | |
| } | |
| } | |

### Sub-Layer HRD Parameters Syntax

| | Descriptor |
|---|---|
| hrd_sub_layer_parameters( subLayerID ) { | |
| for( i = 0; i <= CbmbCnt; i++ ) { | |
| bit_rate_value_minus1[ i ] | ue(v) |
| cbmb_size_value_minus1[ hrdMode ][ subLayerID | ue(v) |
| ][ i ] | |
| if( sub_mesh_hrd_params_present_flag ) { | |
| cbmb_size_du_value_min1[ i ] | ue(v) |
| bit_rate_du_value_min1[ i ] | ue(v) |
| } | |
| cbr_flag[ i ] | u(1) |
| } | |
| } | |

### Buffering Period SEI Message Syntax

| | Descriptor |
|---|---|
| buffering_period( payloadSize ) { | |
| bp_seq_parameter_set_id | ue(v) |
| if( !sub_mesh_hrd_params_present_flag) | |
| irap_cbmb_params_present_flag | u(1) |
| if( irap_cbmb_params_present_flag ) { | |
| cbmb_delay_offset | u(v) |
| dbmb_delay_offset | u(v) |
| } | |
| concatenation_flag | u(1) |
| au_cbmb_removal_delay_delta_minus1 | u(v) |
| if( BmnalHrdBpPresentFlag ) { | |
| for( i = 0; i < CbmbCnt; i++ ) { | |
| bmnal_initial_cbmb_removal_delay[ i ] | u(v) |
| bmnal_initial_cbmb_removal_offset[ i ] | u(v) |
| if( sub_mesh_hrd_params_present_flag \|\| | |
| irap_cbmb_params_present_flag ) { | |
| bmnal_initial_alt_cbmb_removal_delay[ i ][ j ] | u(v) |
| bmnal_initial_alt_cbmb_removal_offset[ i ][ j ] | u(v) |
| } | |
| } | |
| } | |
| if( BmclHrdBpPresentFlag ) { | |
| for( i = 0; i < CbmbCnt; i++ ) { | |
| bmcl_initial_comb_removal_delay[ i ] | u(v) |
| bmcl_initial_comb_removal_offset[ i ][ j ] | u(v) |
| if( sub_mesh_hrd_params_present_flag \|\| | |
| irap_cbmb_params_present_flag ) { | |
| bmcl_initial_alt_cbmb_removal_delay[ i ][ j ] | u(v) |
| bmcl_initial_alt_cbmb_removal_offset[ i ][ j ] | u(v) |
| } | |
| } | |
| } | |
| if( more_data_in_payload( ) ) | |
| use_alt_cpb_params_flag | u(1) |
| } | |

### Basemesh Timing SEI Message Syntax

| | Descriptor |
|---|---|
| basemesh_frame_timing( payloadSize ) { | |
| if( CbmbDbmbDelaysPresentFlag ) { | |
| au_cbmb_removal_delay_minus1 | u(v) |
| bm_dbmb_output_delay | u(v) |
| if( sub_mesh_hrd_params_present_flag \|\| sub_mesh_cbmb_params_in_bm_timing_sei_flag ) { | |
| num_decoding_units_minus1 | ue(v) |
| du_common_cbmb_removal_delay_flag | u(1) |
| if( du_common_cbmb_removal_delay_flag ) | |
| du_common_cbmb_removal_delay_increment_minus1 | u(v) |
| for( i = 0; i <= num_decoding_units_minus1; i++ ) { | |
| du_num_nalus_in_du_minus1[ i ] | ue(v) |
| if( !du_common_cbmb_removal_delay_flag & & i < num_decoding_units_minus1 ) | |
| du_cbmb_removal_delay_increment_minus1[ i ] | u(v) |
| } | |
| } | |
| } | |
| } | |

### Decoding Unit Information SEI Message Syntax

| | Descriptor |
|---|---|
| decoding_unit_info( payloadSize ) { | |
| decoding_unit_idx | ue(v) |
| if( !sub_mesh_cbmb_params_in_bm_timing_sei_flag ) | |
| du_smt_cbmb_removal_delay_increment | u(v) |
| dbmb_output_du_delay_present_flag | u(1) |
| if( dbmb_output_du_delay_present_flag ) | |
| bm_smt_dbmb_output_du_delay | u(v) |
| } | |

### Basemesh Sequence Parameter Semantics

vui_parameters_present_flag equal to 1 specifies that the vui_parameters( ) syntax structure as specified in an Annex is present. vui_parameters_present_flag equal to 0 specifies that the vui_parameters( ) syntax structure as specified in an Annex is not present.

### VUI Semantics

### VUI Parameters Semantics

vui_timing_info_present_flag equal to 1 specifies that vui_num_units_in_tick, vui_time_scale, vui_poc_proportional_to_timing_flag, and vui_hrd_parameters_present_flag are present in the vui_parameters( ) syntax structure. vui_timing_info_present_flag equal to 0 specifies that vui_num_units_in_tick, vui_time_scale, vui_poc_proportional_to_timing_flag, and vui_hrd_parameters_present_flag are not present in the vui_parameters( ) syntax structure. vui_num_units_in_tick is the number of time units of a clock operating at the frequency vui_time_scale Hz that corresponds to one increment (called a clock tick) of a clock tick counter. vui_num_units_in_tick shall be greater than 0. A clock tick, in units of seconds, is equal to the quotient of vui_num_units_in_tick divided by vui_time_scale. For example, when the picture rate of a video signal is 25 Hz, vui_time_scale may be equal to 27 000 000 and vui_num_units_in_tick may be equal to 1 080 000, and consequently a clock tick may be equal to 0.04 seconds.

vui_mfoc_proportional_to_timing_flag equal to 1 indicates that the basemesh frame order count value for each picture in the CBMS that is not the first basemesh frame in the CBMS, in decoding order, is proportional to the output time of the basemesh relative to the output time of the first basemesh in the CBMS. vui_mfoc_proportional_to_timing_flag equal to 0 indicates that the basemesh frame order count value for each basemesh in the CBMS that is not the first basemsh frame in the CBMS, in decoding order, may or may not be proportional to the output time of the basemesh frame relative to the output time of the first basemesh frame in the CBMS. vui_num_ticks_mfoc_diff_one_minus1 plus 1 specifies the number of clock ticks corresponding to a difference of basemesh frame order count values equal to 1. The value of vui_num_ticks_mfoc_diff_one_minus1 shall be in the range of 0 to 232-2, inclusive. vui_hrd_parameters_present_flag equal to 1 specifies that the syntax structure hrd_parameters( ) is present in the vui_parameters( ) syntax structure. vui_hrd_parameters_present_flag equal to 0 specifies that the syntax structure hrd_parameters( ) is not present in the vui_parameters( ) syntax structure.

### HRD Parameters Semantics

The hrd_parameters( ) syntax structure provides HRD parameters used in the HRD operations for a layer set. It is a requirement that for this version of the specification the layer set contains a layer with a single bmesh_nal_layer_id and with the HighestTid equal to 0. When the hrd_parameters( ) syntax structure is included in basemesh SPS, the layer set to which the hrd_parameters( ) syntax structure applies is the layer set for which the associated layer identifier list contains all bmesh_nal_layer_id with values of 0, present in the CBMS. bmnal_hrd_parameters_present_flag equal to 1 specifies that BM NAL HRD parameters (pertaining to the Type II bitstream conformance point) are present in the hrd_parameters( ) syntax structure. bmnal_hrd_parameters_present_flag equal to 0 specifies that BM NAL HRD parameters are not present in the hrd_parameters( ) syntax structure.

When bmnal_hrd_parameters_present_flag is equal to 0, the conformance of the bitstream cannot be verified without provision of the BM NAL HRD parameters and all buffering period SEI messages, and, when bmcl_hrd_parameters_present_flag is also equal to 0, all basemsh timing and decoding unit information SEI messages, by some means not specified in this document.

The variable BMNalHrdBpPresentFlag is derived as follows:
If one or more of the following conditions are true, the value of BMNalHrdBpPresentFlag is set equal to 1:
bmnal_hrd_parameters_present_flag is present in the bitstream and is equal to 1.
The need for the presence of buffering period parameters for BM NAL HRD operation in the bitstream in buffering period SEI messages is determined by the application, by some means not specified in this document.
Otherwise, the value of BMNalHrdBpPresentFlag is set equal to 0. bmcl_hrd_parameters_present_flag equal to 1 specifies that BMCL HRD parameters (pertaining to the Type I bitstream conformance point) are present in the hrd_parameters( ) syntax structure. bmcl_hrd_parameters_present_flag equal to 0 specifies that BMCL HRD parameters are not present in the hrd_parameters( ) syntax structure.

When bmcl_hrd_parameters_present_flag is equal to 0, the conformance of the bitstream cannot be verified without provision of the BMCL HRD parameters and all buffering period SEI messages, and, when bmnal_hrd_parameters_present_flag is also equal to 0, all basemesh timing and decoding unit information SEI messages, by some means not specified in this document.

The variable BmclHrdBpPresentFlag is derived as follows:
If one or more of the following conditions are true, the value of BmclHrdBpPresentFlag is set equal to 1:
bmcl_hrd_parameters_present_flag is present in the bitstream and is equal to 1.

The need for the presence of buffering period parameters for BMCL HRD operation in the bitstream in buffering period SEI messages is determined by the application, by some means not specified in this document.

Otherwise, the value of BmclHrdB pPresentFlag is set equal to 0.

The variable CbmbDbmbDelaysPresentFlag is derived as follows:
If one or more of the following conditions are true, the value of CbmbDbmbDelaysPresentFlag is set equal to 1:
bmnal_hrd_parameters_present_flag is present in the bitstream and is equal to 1.
bmcl_hrd_parameters_present_flag is present in the bitstream and is equal to 1.
The need for the presence of CBMB and DBMB output delays in the bitstream in basemseh timing SEI messages is determined by the application, by some means not specified in this document.
Otherwise, the value of CbmbDbmbDelaysPresentFlag is set equal to 0.

When BMNalHrdBpPresentFlag and BmclHrdBpPresentFlag are both equal to 0, the value of CpbDpbDelaysPresentFlag shall be equal to 0.

sub_mesh_hrd_params_present_flag equal to 1 specifies that submesh level HRD parameters are present and the HRD may operate at access unit level or submesh level. sub_mesh_hrd_params_present_flag equal to 0 specifies that submesh level HRD parameters are not present and the HRD operates at access unit level. When sub_mesh_hrd_params_present_flag is not present, its value is inferred to be equal to 0. tick_divisor_minus2 is used to specify the clock sub-tick. A clock sub-tick is the minimum interval of time that can be represented in the coded data when sub_mesh_hrd_params_present_flag is equal to 1. du_cbmb_removal_delay_increment_length_minus1 plus 1 specifies the length, in bits, of the du_cbmb_removal_delay_increment_minus1[i] and du_common_cbmb_removal_delay_increment_minus1 syntax elements of the basemesh timing SEI message and the du_smt_cbmb_removal_delay_increment syntax element in the decoding unit information SEI message.

sub_mesh_cbmb_params_in_bm_timing_sei_flag equal to 1 specifies that submesh level CBMB removal delay parameters are present in basemesh timing SEI messages and no decoding unit information SEI message is available (in the CBMS or provided through external means not specified in this document). sub_mesh_cbmb_params_in_bm_timing_sei_flag equal to 0 specifies that submesh level CBMB removal delay parameters are present in decoding unit information SEI messages and basemesh timing SEI messages do not include submesh level CBMB removal delay parameters. When the sub_mesh_cbmb_params_in_bm_timing_sei_flag syntax element is not present, it is inferred to be equal to 0.

dbmb_output_delay_du_length_minus1 plus 1 specifies the length, in bits, of the bm_dpb_output_du_delay syntax element in the basemesh timing SEI message and the bm_smt_dbmb_output_du_delay syntax element in the decoding unit information SEI message. bit_rate_scale (together with bit_rate_value_minus1[i]) specifies the maximum input bit rate of the i-th CBMB.

cbmb_size_scale (together with cbmb_size_value_minus1[i]) specifies the CBMB size of the i-th CBMB when the CBMB operates at the access unit level.

cbmb_size_du_scale (together with comb_size_du_value_minus1[i]) specifies the CBMB size of the i-th CBMB when the CBMB operates at submesh level. initial_cbmb_removal_delay_length_minus1 plus 1 specifies the length, in bits, of the bmnal_initial_cbmb_removal_delay[i], bmnal_initial_cbmb_removal_offset[i], bmcl_initial_cbmb_removal_delay[i], and bmcl_initial_cbmb_removal_offset[i] syntax elements of the buffering period SEI message. When the initial_cbmb_removal_delay_length_minus1 syntax element is not present, it is inferred to be equal to 23.

au_cbmb_removal_delay_length_minus1 plus 1 specifies the length, in bits, of the cbmb_delay_offset syntax element in the buffering period SEI message and the au_cbmb_removal_delay_minus1 syntax element in the basemesh timing SEI message. When the au_cbmb_removal_delay_length_minus1 syntax element is not present, it is inferred to be equal to 23.

dbmb_output_delay_length_minus1 plus 1 specifies the length, in bits, of the dbmb_delay_offset syntax element in the buffering period SEI message and the bm_dbmb_output_delay syntax element in the basemesh timing SEI message. When the dbmb_output_delay_length_minus1 syntax element is not present, it is inferred to be equal to 23.

fixed_bm_rate_general_flag[i] equal to 1 indicates that, when HighestTid is equal to i, the temporal distance between the HRD output times of consecutive basemeshes in output order is constrained as specified below. fixed_bm_rate_general_flag[i] equal to 0 indicates that this constraint may not apply.

When fixed_bm_rate_general_flag[i] is not present, it is inferred to be equal to 0. fixed_bm_rate_within_cbms_flag[i] equal to 1 indicates that, when HighestTid is equal to i, the temporal distance between the HRD output times of consecutive pictures in output order is constrained as specified below. fixed_bm_rate_within_cbms_flag[i] equal to 0 indicates that this constraint may not apply.

When fixed_bm_rate_general_flag[i] is equal to 1, the value of fixed_bm_rate_within_cbms_flag[i] is inferred to be equal to 1. elemental_duration_in_to_minus1[i] plus 1 (when present) specifies, when HighestTid is equal to i, the temporal distance, in clock ticks, between the elemental units that specify the HRD output times of consecutive basemeshes in output order as specified below. The value of elemental_duration_in_to_minus1[i] shall be in the range of 0 to 2 047, inclusive.

When HighestTid is equal to i and fixed_bm_rate_within_cbms_flag[i] is equal to 1 for a CBMS containing basemesh n, and for each basemsh n that is output and not the last basemesh in the bitstream (in output order) that is output, the value of the variable DbmbOutputElementalInterval[n] is specified by:

$$DbmbOutputElementalInterval [ n ] = DbmbOutputTime [ nextBmInOutputOrder ] - DbmbOutputTime [ n ]$$

When HighestTid is equal to i and fixed_bm_rate_within_cbms_flag[i] is equal to 1 for a CBMS containing basemesh n, the value computed for DbmbOutputElementalInterval[n] shall be equal to ClockTick*(elemental_duration_in_to_minus1[i]+1), wherein ClockTick is as specified as ClockTick=vui_num_units_in_tick÷vui_time_scale (using the value of ClockTick for the CBMS containing basemesh n) when one of the following conditions is true for the following basemsh in output order nextBmInOutputOrder that is:
basemesh nexBmInOutputOrder is in the same CBMS as basemesh n.
basemsh nextBmInOutputOrder is in a different CBMS and fixed_bm_rate_general_flag[i] is equal to 1 in the CBMS containing basemesh nextBmInOutputOrder, the value of ClockTick is the same for both CBMSs, and the value of elemental_duration_in_to_minus1[i] is the same for both CBMSs. low_delay_hrd_flag[i] specifies the HRD operational mode, when HighestTid is equal to i. When not present, the value of low_delay_hrd_flag[i] is inferred to be equal to 0.

When low_delay_hrd_flag[i] is equal to 1, “big basemeshes” that violate the nominal CBMB removal times due to the number of bits used by an access unit are permitted. It is expected, but not required, that such “big basemeshes” occur only occasionally. cbmb_cnt_minus1[i] plus 1 specifies the number of alternative CBMB specifications in the bitstream of the CBMS when HighestTid is equal to i. The value of cbmb_cnt_minus1[i] shall be in the range of 0 to 31, inclusive. When not present, the value of cbmb_cnt_minus1[i] is inferred to be equal to 0.

### Sub-Layer HRD Parameters Semantics

The variable CombCnt is set equal to comb_cnt_minus1[sublayerId]+1. bit_rate_value_minus1[i] (together with bit_rate_scale) specifies the maximum input bit rate for the i-th CBMB when the CBMB operates at the access unit level. bit_rate_value_minus1[i] shall be in the range of 0 to 232-2, inclusive. For any i>0, bit_rate_value_minus1[i] shall be greater than bit_rate_value_minus1[i−1].

When SubMeshHrdFlag is equal to 0, the bit rate in bits per second is given by:

$$BitRate [ i ] = ( bit\_rate \_value \_minus1 [ i ] + 1 ) * {2}^{( 6 + bit \_ rate \_ scale )}$$

When SubMeshHrdFlag is equal to 0 and the bit_rate_value_minus1[i] syntax element is not present, the value of BitRate[i] is inferred to be equal to BrBmclFactor*MaxBR for BMCL HRD parameters and to be equal to BrBM NalFactor*MaxBR for BM NAL HRD parameters, where MaxBR, BrBM clFactor and BrBM NalFactor are specified in A.4. cbmb_size_value_minus1[i] is used together with cbmb_size_scale to specify the i-th CBMB size when the CBMB operates at the access unit level. cbmb_size_value_minus1[i] shall be in the range of 0 to 232-2, inclusive. For any i greater than 0, comb_size_value_minus1[i] shall be less than or equal to comb_size_value_minus1[i−1].

When SubMeshHrdFlag is equal to 0, the CBMB size in bits is given by:

$$CbmbSize [ i ] = ( cbmb\_size \_value \_minus1 [ i ] + 1 ) * {2}^{( 4 + cbmb \_ size \_ scale )}$$

When SubMeshHrdFlag is equal to 0 and the comb_size_value_minus1[i] syntax element is not present, the value of CbmbSize[i] is inferred to be equal to CombBmclFactor*MaxCBMB for BMCL HRD parameters and to be equal to CombB M NalFactor*MaxCBMB for BMNAL HRD parameters, where MaxCBMB, CbmBM clFactor and CbmbB M NalFactor are specified in A.4. cbmb_size_du_value_minus1[i] is used together with comb_size_du_scale to specify the i-th CBMB size when the CBMB operates at submesh level. comb_size_du_value_minus1[i] shall be in the range of 0 to 2³²−2, inclusive. For any i greater than 0, cbmb_size_du_value_minus1[i] shall be less than or equal to cbmb_size_du_value_minus1[i−1].

When SubMeshHrdFlag is equal to 1, the CBMB size in bits is given by:

$$CbmbSize [ i ] = ( cbmb\_size \_du \_value \_minus1 [ i ] + 1 ) * {2}^{( 4 + cbmb \_ size \_ du \_ scale )} \qquad ( E - 79 )$$

When SubMeshHrdFlag is equal to 1 and the comb_size_du_value_minus1[i] syntax element is not present, the value of CbmbSize[i] is inferred to be equal to CbmbB mclFactor*MaxCBMB for BMCL HRD parameters and to be equal to CombNalFactor*MaxCBMB for BM NAL HRD parameters, where MaxCBMB, CbmbBmclFactor and CbmbN alFactor are specified in A.4. bit_rate_du_value_minus1[i] (together with bit_rate_scale) specifies the maximum input bit rate for the i-th CBMB when the CBMB operates at the submesh level. bit_rate_du_value_minus1[i] shall be in the range of 0 to 232-2, inclusive. For any i>0, bit_rate_du_value_minus1[i] shall be greater than bit_rate_du_value_minus1[i−1]. When SubMeshHrdFlag is equal to 1, the bit rate in bits per second is given by:

$$BitRate [ i ] = ( bit\_rate \_du \_value \_minus1 [ i ] + 1 ) * {2}^{( 6 + bit \_ rate \_ scale )}$$

When SubMeshHrdFlag is equal to 1 and the bit_rate_du_value_minus1[i] syntax element is not present, the value of BitRate[i] is inferred to be equal to BrBmclFactor*MaxBR for BMCL HRD parameters and to be equal to BrB M NalFactor*MaxBR for BM NAL HRD parameters, where MaxBR, BrBM clFactor and BrBM NalFactor are specified in A.4. cbr_flag[i] equal to 0 specifies that to decode this CBMS by the HRD using the i-th CBMB specification, the hypothetical stream scheduler (HSS) operates in an intermittent bit rate mode. cbr_flag[i] equal to 1 specifies that the HSS operates in a constant bit rate (CBR) mode. When not present, the value of cbr_flag[i] is inferred to be equal to 0.

### Buffering Period SEI Message Semantics

A buffering period SEI message provides initial CBMB removal delay and initial CBMB removal delay offset information for initialization of the HRD at the position of the associated access unit in decoding order.

When the buffering period SEI message is non-scalable-nested or is directly contained in a scalable nesting SEI message within an SEI NAL unit with bmesh_nal_layer_id equal to 0 and the current access unit is a CRA or BLA access unit, let skippedBasemeshList be the list of skipped leading basemeshes including the RASL basemeshes associated with the CRA or BLA access unit with which the buffering period SEI message is associated.

When the buffering period SEI message is non-scalable-nested or is directly contained in a scalable nesting SEI message within an SEI NAL unit with bmesh_nal_layer_id equal to 0, a basemesh is said to be a notDiscardableB m basemesh when the basemesh has TemporalId equal to 0, and is not a RASL, RADL, or SLNR basemesh.

When the buffering period SEI message is non-scalable-nested or is directly contained in a scalable nesting SEI message within an SEI NAL unit with bmesh_nal_layer_id equal to 0, the following applies for the buffering period SEI message syntax and semantics:
The syntax elements initial_cbmb_removal_delay_length_minus1, au_cbmb_removal_delay_length_minus1, dbmb_output_delay_length_minus1, and sub_mesh_hrd_params_present_flag, and the variables BMNalHrdBpPresentFlag and BMclHrdBpPresentFlag are found in or derived from syntax elements found in the hrd_parameters( ) syntax structure that is applicable to at least one of the operation points to which the buffering period SEI message applies.
The variables CbmbSize[i], BitRate[i] and CbmbCnt are derived from syntax elements found in the sub_layer_hrd_parameters( ) syntax structure that is applicable to at least one of the operation points to which the buffering period SEI message applies.
Any two operation points that the buffering period SEI message applies to having different OpTid values tldA and tldB indicate that the values of cbmb_cnt_minus1[tldA] and cpb_cnt_minus1[tldB] coded in the hrd_parameters( ) syntax structure(s) applicable to the two operation points are identical.
Any two operation points that the buffering period SEI message applies to having different OpLayerIdList values layerIdListA and layerIdListB indicate that the values of bmnal_hrd_parameters_present_flag and bmcl_hrd_parameters_present_flag, respectively, for the two hrd_parameters( ) syntax structures applicable to the two operation points are identical.
The bitstream (or a part thereof) refers to the bitstream subset (or a part thereof) associated with any of the operation points to which the buffering period SEI message applies.

The presence of buffering period SEI messages for an operation point including the base layer is specified as follows:
If BM NalHrdBpPresentFlag is equal to 1 or BM clHrdBpPresentFlag is equal to 1, the following applies for each access unit in the CBMS:
If the access unit is an IRAP access unit, a buffering period SEI message applicable to the operation point shall be associated with the access unit.
   Otherwise, if the access unit contains a notDiscardableBm, a buffering period SEI message applicable to the operation point may or may not be associated with the access unit.
   Otherwise, the access unit shall not be associated with a buffering period SEI message applicable to the operation point.
Otherwise (BM NalHrdBpPresentFlag and BM clHrdBpPresentFlag are both equal to 0), no access unit in the CBMS shall be associated with a buffering period SEI message applicable to the operation point.

For some applications, frequent presence of buffering period SEI messages could be desirable (e.g., for random access at an IRAP basemesh or a non-IRAP basemesh or for bitstream splicing).

bp_seq_parameter_set_id indicates and shall be equal to the bmsps_seq_parameter_set_id for the basemesh SPS that is active for the coded basemesh associated with the buffering period SEI message. The value of bp_seq_parameter_set_id shall be equal to the value of bmfps_seq_parameter_set_id in the basemesh FPS referenced by the bmsh_basemesh_frame_parameter_set_id of the basemesh submesh segment headers of the coded basemesh associated with the buffering period SEI message. The value of bp_seq_parameter_set_id shall be in the range of 0 to 15, inclusive.

irap_cbmb_params_present_flag equal to 1 specifies the presence of the bmnal_initial_alt_cbmb_removal_delay[i] and bmnal_initial_alt_cbmb_removal_offset[i] or bmcl_initial_alt_cbmb_removal_delay[i] and bmcl_initial_alt_cpb_removal_offset[i] syntax elements. When not present, the value of irap_cbmb_params_present_flag is inferred to be equal to 0. When the associated basemesh is neither a CRA basemesh nor a BLA basemesh, the value of irap_cbmb_params_present_flag shall be equal to 0.

The values of sub_mesh_hrd_params_present_flag and irap_cbmb_params_present_flag cannot be both equal to 1.

cbmb_delay_offset specifies an offset to be used in the derivation of the nominal CBMB removal times of access units following, in decoding order, the CRA or BLA access unit associated with the buffering period SEI message when no basemesh in skippedPictureList is present. The syntax element has a length in bits given by au_cbmb_removal_delay_length_minus1+1. When not present, the value of cbmb_delay_offset is inferred to be equal to 0.

dbmb_delay_offset specifies an offset to be used in the derivation of the DBMB output times of the CRA or BLA access unit associated with the buffering period SEI message when no basemesh in skippedPictureList is present. The syntax element has a length in bits given by dbmb_output_delay_length_minus1+1. When not present, the value of dbmb_delay_offset is inferred to be equal to 0.

When the current basemesh is not the first basemesh in the bitstream in decoding order, let prevNonDiscardableBm be the preceding basemesh in decoding order with TemporalId equal to 0 that is not a RASL, RADL, or SLNR basemesh.

concatenation_flag indicates, when the current basemesh is not the first basemesh in the bitstream in decoding order, whether the nominal CBMB removal time of the current basemesh is determined relative to the nominal CBMB removal time of the preceding basemesh with a buffering period SEI message or relative to the nominal CBMB removal time of the basemesh prevNonDiscardableBm.

au_cbmb_removal_delay_delta_minus1 plus 1, when the current basemesh is not the first basemesh in the bitstream in decoding order, specifies a CBMB removal delay increment value relative to the nominal CBMB removal time of the basemesh prevNonDiscardableBm. This syntax element has a length in bits given by au_cbmb_removal_delay_length_minus1+1.

When the current basemesh contains a buffering period SEI message and concatenation_flag is equal to 0 and the current basemesh is not the first basemesh in the bitstream in decoding order, it is a requirement of bitstream conformance that the following constraint applies:
If the basemesh prevNonDiscardableBm is not associated with a buffering period SEI message, the au_cbmb_removal_delay_minus1 of the current basemesh shall be equal to the au_cbmb_removal_delay_minus1 of prevNonDiscardableBm plus au_cbmb_removal_delay_delta_minus1+1.
Otherwise, au_cbmb_removal_delay_minus1 shall be equal to au_cbmb_removal_delay_delta_minus1.

When the current basemesh contains a buffering period SEI message and concatenation_flag is equal to 1, the au_cbmb_removal_delay_minus1 for the current basemesh is not used. The above-specified constraint can, under some circumstances, make it possible to splice bitstreams (that use suitably-designed referencing structures) by simply changing the value of concatenation_flag from 0 to 1 in the buffering period SEI message for an IRAP basemesh at the splicing point. When concatenation_flag is equal to 0, the above-specified constraint enables the decoder to check whether the constraint is satisfied as a way to detect the loss of the basemesh prevNonDiscardableBm.

bmnal_initial_cbmb_removal_delay[i] and bmnal_initial_alt_cbmb_removal_delay[i] specify the default and the alternative initial CBMB removal delays, respectively, for the i-th CBMB when the BMNAL HRD parameters are in use. The syntax elements have a length in bits given by initial_cbmb_removal_delay_length_minus1+1, and are in units of a 90 kHz clock. The values of the syntax elements shall not be equal to 0 and shall be less than or equal to 90000*(CbmbSize[i]=BitRate[i]), the time-equivalent of the CBMB size in 90 KHz clock units.

bmnal_initial_cpb_removal_offset[i] and bmnal_initial_alt_cpb_removal_offset[i] specify the default and the alternative initial CBMB removal offsets, respectively, for the i-th CBMB when the BM NAL HRD parameters are in use. The syntax elements have a length in bits given by initial_cbmb_removal_delay_length_minus1+1 and are in units of a 90 kHz clock.

Over the entire CBMS, the sum of bmnal_initial_cbmb_removal_delay[i] and bmnal_initial_cbmb_removal_offset[i] shall be constant for each value of i, and the sum of bmnal_initial_alt_cbmb_removal_delay[i] and nal_initial_alt_cbmb_removal_offset[i] shall be constant for each value of i.

bmvcl_initial_cbmb_removal_delay[i] and bmcl_initial_alt_cbmb_removal_delay[i] specify the default and the alternative initial CBMB removal delays, respectively, for the i-th CBMB when the BMCL HRD parameters are in use. The syntax elements have a length in bits given by initial_cbmb_removal_delay_length_minus1+1, and are in units of a 90 KHz clock. The values of the syntax elements shall not be equal to 0 and shall be less than or equal to 90000*(CbmbSize[i]=BitRate[i]), the time-equivalent of the CBMB size in 90 kHz clock units.

bmvcl_initial_cbmb_removal_offset[i] and bmvcl_initial_alt_cbmb_removal_offset[i] specify the default and the alternative initial CBMB removal offsets, respectively, for the i-th CBMB when the BMCL HRD parameters are in use. The syntax elements have a length in bits given by initial_cbmb_removal_delay_length_minus1+1 and are in units of a 90 kHz clock.

Over the entire CBMS, the sum of bmcl_initial_cbmb_removal_delay[i] and bmcl_initial_cbmb_removal_offset[i] shall be constant for each value of i, and the sum of bmcl_initial_alt_cbmb_removal_delay[i] and bmcl_initial_alt_cbmb_removal_offset[i] shall be constant for each value of i.

Encoders are recommended not to include irap_cbmb_params_present_flag equal to 1 in buffering period SEI messages associated with a CRA or BLA basemesh for which at least one of its associated RASL basemeshes follows one or more of its associated RADL basemeshes in decoding order.

use_alt_cbmb_params_flag may be used to derive the value of UseAItCbmbParamsFlag. When irap_cbmb_params_present_flag is equal to 0, use_alt_cbmb_params_flag shall not be equal to 1. When use_alt_cbmb_params_flag is not present, it is inferred to be equal to 0.

The syntax element use_alt_cbmb_params_flag can be present in the payload extension of the buffering period SEI message. Decoders conforming to profiles specified in Annex XXX can ignore this syntax element.

It is a requirement of bitstream conformance that when use_alt_cbmb_params_flag is present in the buffering period SEI message, the return value of the more_data_in_payload( ) function in the sei_payload( ) syntax structure containing the buffering period SEI message shall be equal to 1.

### Basemesh Timing SEI Message Semantics

The picture timing SEI message provides CBMB removal delay and DBMB output delay information for the access unit associated with the SEI message.

When the buffering period SEI message is non-scalable-nested or is directly contained in a scalable nesting SEI message within an SEI NAL unit with bmesh_nal_layer_id equal to 0, the following applies for the basemesh timing SEI message syntax and semantics:

The syntax elements sub_mesh_hrd_params_present_flag, sub_mesh_cbmb_params_in_bm_timing_sei_flag, au_cbmb_removal_delay_length_minus1, dbmb_output_delay_length_minus1, dbmb_output_delay_du_length_minus1, du_cbmb_removal_delay_increment_length_minus1, and the variable CbmbDbmbDelaysPresentFlag are found in or derived from syntax elements found in the hrd_parameters( ) syntax structure that is applicable to at least one of the operation points to which the picture timing SEI message applies.

The bitstream (or a part thereof) refers to the bitstream subset (or a part thereof) associated with any of the operation points to which the picture timing SEI message applies.

The syntax of the basemesh timing SEI message is dependent on the content of the hrd_parameters( ) syntax structures applicable to the operation points to which the basemesh timing SEI message applies. These hrd_parameters( ) syntax structure in the SPS that is active for the coded basemesh associated with the basemesh timing SEI message. When the basemesh timing SEI message is associated with an IRAP access unit with NoRaslOutputFlag equal to 1, unless it is preceded by an active parameter sets SEI message within the same access unit, the activation of the SPS (and, for IRAP basemesh with NoRaslOutputFlag equal to 1 that are not the first basemesh in the bitstream in decoding order, the determination that the coded basemesh is an IRAP access unit with NoRaslOutputFlag equal to 1) does not occur until the decoding of the first coded submesh segment NAL unit of the coded basemesh. Since the coded submesh segment NAL unit of the coded basemesh follows the basemesh timing SEI message in NAL unit order, there can be cases in which it is necessary for a decoder to store the RBSP containing the basemesh timing SEI message until determining the active SPS for the coded basemesh, and then perform the parsing of the basemesh timing SEI message.

au_cbmb_removal_delay_minus1 plus 1 is used to calculate the number of clock ticks between the nominal CBMB removal times of the access unit associated with the basemesh timing SEI message and the preceding access unit in decoding order that contained a buffering period SEI message. This value is also used to calculate an earliest possible time of arrival of access unit data into the CBMB for the HSS. The syntax element is a fixed length code whose length in bits is given by au_cbmb_removal_delay_length_minus1+1.

The value of au_cbmb_removal_delay_length_minus1 that determines the length (in bits) of the syntax element au_cbmb_removal_delay_minus1 is the value of au_cbmb_removal_delay_length_minus1 coded in the SPS that is active for the coded basemesh associated with the basemesh timing SEI message, although the preceding access unit containing a buffering period SEI message can be an access unit of a different CBMS.

The variable BpResetFlag of the current basemesh is derived as follows.
If the current basemesh is associated with a buffering period SEI message that is applicable to at least one of the operation points to which the basemesh timing SEI message applies, BpResetFlag is set equal to 1.
Otherwise, BpResetFlag is set equal to 0.

The variables AuCbmbRemovalDelayMsb and AuCbmbRemovalDelayVal of the current basemesh are derived as follows.
If the current access unit is the access unit that initializes the HRD, AuCbmbRemovalDelayMsb and AuCbmbRemovalDelayVal are both set equal to 0.
Otherwise, let the basemesh prevNonDiscardableBm be the previous basemesh in decoding order that has TemporalId equal to 0 that is not a RASL, RADL, or SLNR picture, let prevAuCbmbRemovalDelayMinus1, prevAuCbmbRemovalDelayMsb, and prevBpResetFlag be set equal to the values of au_cbmb_removal_delay_minus1, AuCbmbRemovalDelayMsb, and BpResetFlag, respectively, for the basemesh prevNonDiscardableBm, and the following applies:
AuCbmbRemovalDelayM sb is derived as follows:

| | |
|---|---|
| if( prevBpResetFlag ) | |
| AuCbmbRemovalDelayMsb = 0 | |
| else if( au_cbmb_removal_delay_minus1 <= prevAuCbmbRemovalDelayMinus1 ) | |
| AuCbmbRemovalDelayMsb = prevAuCbmbRemovalDelayMsb + | |
| 2^{au}^{_{—}}^{cbmb}^{_{—}}^{removal}^{_{—}}^{delay}^{_{—}}^{length}^{_{—}}^{minus1 + 1} | (D-1) |
| else | |
| AuCbmbRemovalDelayMsb = prevAuCbmbRemovalDelayMsb | |

AuCbmbRemovalDelayVal is derived as follows:

$$AuCbmbRemovalDelayVal = AuCbmbRemovalDelayMsb + au\_cbmb \_removal \_delay \_minus1 + 1 \qquad ( D - 2 )$$

The value of AuCbmbRemovalDelayVal shall be in the range of 1 to 2³², inclusive.

bm_dbmb_output_delay is used to compute the DBMB output time of the basemesh when SubMeshHrdFlag is equal to 0. It specifies how many clock ticks to wait after removal of the last decoding unit in an access unit from the CBMB before the decoded basemesh is output from the DBMB.

A basemesh is not removed from the DBMB at its output time when it is still marked as “used for short-term reference” or “used for long-term reference”.

The length of the syntax element bm_dbmb_output_delay is given in bits by dbmb_output_delay_length_minus1+1. When bmsps_max_dec_mesh_frame_buffering_minus1 is equal to 0, the basemesh timing SEI message applies to, bm_dbmb_output_delay shall be equal to 0.

The output time derived from the bm_dbmb_output_delay of any basemesh that is output from an output timing conforming decoder shall precede the output time derived from the bm_dbmb_output_delay of all basemeshes in any subsequent CBMS in decoding order.

The basemesh output order established by the values of this syntax element shall be the same order as established by the values of FrmOrderCntVal.

For basemeshes that are not output by the “bumping” process because they precede, in decoding order, an IRAP basemesh with NoRasIOutputFlag equal to 1 that has NoOutputOfPriorBmsFlag equal to 1, the output times derived from bm_dbmb_output_delay shall be increasing with increasing value of FrmOrderCntVal relative to all basemeshes within the same CBMS.

bm_dbmb_output_du_delay is used to compute the DBMB output time of the basemesh when SubMeshHrdFlag is equal to 1. It specifies how many sub clock ticks to wait after removal of the last decoding unit in an access unit from the CBMB before the decoded basemesh is output from the DBMB.

The length of the syntax element bm_dbmb_output_du_delay is given in bits by dbmb_output_delay_du_length_minus1+1.

The output time derived from the bm_dbmb_output_du_delay of any basemesh that is output from an output timing conforming decoder shall precede the output time derived from the bm_dbmb_output_du_delay of all basemeshes in any subsequent CBMS in decoding order.

The basemesh output order established by the values of this syntax element shall be the same order as established by the values of FrmOrderCntVal.

For basemeshes that are not output by the “bumping” process because they precede, in decoding order, an IRAP basemesh with NoRaslOutputFlag equal to 1 that has NoOutputOfPriorBmsFlag equal to 1, the output times derived from bm_dbmb_output_du_delay shall be increasing with increasing value of FrmOrderCntVal relative to all basemeshes within the same CBMS.

For any two basemeshes in the CBMS, the difference between the output times of the two basemeshes when SubMeshHrdFlag is equal to 1 shall be identical to the same difference when SubMeshHrdFlag is equal to 0.

num_decoding_units_minus1 plus 1 specifies the number of decoding units in the access unit the basemesh timing SEI message is associated with. The value of num_decoding_units_minus1 shall be in the range of 0 to MaxNumSubmeshes [frameIdx]−1, inclusive.

du_common_cbmb_removal_delay_flag equal to 1 specifies that the syntax element du_common_cbmb_removal_delay_increment_minus1 is present. du_common_cbmb_removal_delay_flag equal to 0 specifies that the syntax element du_common_cbmb_removal_delay_increment_minus1 is not present.

du_common_cbmb_removal_delay_increment_minus1 plus 1 specifies the duration, in units of clock sub-ticks, between the nominal CBMB removal times of any two consecutive decoding units in decoding order in the access unit associated with the basemesh timing SEI message. This value is also used to calculate an earliest possible time of arrival of decoding unit data into the CBMB for the HSS. The syntax element is a fixed length code whose length in bits is given by du_cbmb_removal_delay_increment_length_minus1+1.

du_num_nalus_in_du_minus1[i] plus 1 specifies the number of NAL units in the i-th decoding unit of the access unit the basemesh timing SEI message is associated with. The value of du_num_nalus_in_du_minus1[i] shall be in the range of 0 to MaxNumSubmeshes [frameIdx]−1, inclusive.

The first decoding unit of the access unit includes the first num_nalus_in_du_minus1[0]+1 consecutive NAL units in decoding order in the access unit. The i-th (with i greater than 0) decoding unit of the access unit includes the du_num_nalus_in_du_minus1[i]+1 consecutive NAL units immediately following the last NAL unit in the previous decoding unit of the access unit, in decoding order. There shall be at least one BMCL NAL unit in each decoding unit. All non-BMCL NAL units associated with a BMCL NAL unit shall be included in the same decoding unit as the BMCL NAL unit.

du_cbmb_removal_delay_increment_minus1[i] plus 1 specifies the duration, in units of clock sub-ticks, between the nominal CBMB removal times of the (i+1)-th decoding unit and the i-th decoding unit, in decoding order, in the access unit associated with the basemesh timing SEI message. This value is also used to calculate an earliest possible time of arrival of decoding unit data into the CBMB for the HSS. The syntax element is a fixed length code whose length in bits is given by du_cbmb_removal_delay_increment_length_minus1+1.

### Decoding Unit Information SEI Message Semantics

The decoding unit information SEI message provides CBMB removal delay information for the decoding unit associated with the SEI message.

When the buffering period SEI message is non-scalable-nested or is directly contained in a scalable nesting SEI message within an SEI NAL unit with bmesh_nal_layer_id equal to 0, the following applies for the decoding unit information SEI message syntax and semantics:
The syntax elements sub_mesh_hrd_params_present_flag, sub_mesh_cbmb_params_in_bm_timing_sei_flag, and dbmb_output_delay_du_length_minus1, and the variable CbmbDbmbDelaysPresentFlag are found in or derived from syntax elements in the hrd_parameters( ) syntax structure that is applicable to at least one of the operation pints to which the decoding unit information SEI message applies.
The bitstream (or a part thereof) refers to the bitstream subset (or a part thereof) associated with any of the operation points to which the decoding unit information SEI message applies.

The presence of decoding unit information SEI messages for an operation point including the base layer is specified as follows:
If CbmbDbmbDelaysPresentFlag is equal to 1, sub_mesh_hrd_params_present_flag is equal to 1, and sub_mesh_cbmb_params_in_bm_timing_sei_flag is equal to 0, one or more decoding unit information SEI messages applicable to the operation point shall be associated with each decoding unit in the CBMS.
Otherwise, if CbmbDbmbDelaysPresentFlag is equal to 1, sub_mesh_hrd_params_present_flag is equal to 1, and sub_mesh_cbmb_params_in_bm_timing_sei_flag is equal to 1, one or more decoding unit information SEI messages applicable to the operation point may or may not be associated with each decoding unit in the CBMS.
Otherwise (CbmbDbmbDelaysPresentFlag is equal to 0 or sub_mesh_hrd_params_present_flag is equal to 0), in the CBMS there shall be no decoding unit that is associated with a decoding unit information SEI message applicable to the operation point.

When the buffering period SEI message is non-scalable-nested or is directly contained in a scalable nesting SEI message within an SEI NAL unit with bmesh_nal_layer_id equal to 0, the set of BMNAL units associated with a decoding unit information SEI message includes, in decoding order, the SEI NAL unit containing the decoding unit information SEI message and all subsequent NAL units in the access unit up to but not including any subsequent SEI NAL unit containing a decoding unit information SEI message with a different value of decoding_unit_idx. Each decoding unit shall include at least one BMCL NAL unit. All non-BMCL NAL units associated with a BMCL NAL unit shall be included in the decoding unit containing the BMCL NAL unit.

decoding_unit_idx specifies the index, starting from 0, to the list of decoding units in the current access unit, of the decoding unit associated with the decoding unit information SEI message. The value of decoding_unit_idx shall be in the range of 0 to MaxNumSubmeshes [frameIdx]−1, inclusive.

A decoding unit identified by a particular value of duldx includes and only includes all NAL units associated with all decoding unit information SEI messages that have decoding_unit_idx equal to duldx. Such a decoding unit is also referred to as associated with the decoding unit information SEI messages having decoding_unit_idx equal to duldx.

For any two decoding units duA and duB in one access unit with decoding_unit_idx equal to duldxA and duldxB, respectively, where duldxA is less than duldxB, duA shall precede duB in decoding order.

A BMNAL unit of one decoding unit shall not be present, in decoding order, between any two BMNAL units of another decoding unit.

du_smt_cpb_removal_delay_increment specifies the duration, in units of clock sub-ticks, between the nominal CBMB times of the last decoding unit in decoding order in the current access unit and the decoding unit associated with the decoding unit information SEI message. This value is also used to calculate an earliest possible time of arrival of decoding unit data into the CBMB for the HSS. The syntax element is represented by a fixed length code whose length in bits is given by du_cbmb_removal_delay_increment_length_minus1+1. When the decoding unit associated with the decoding unit information SEI message is the last decoding unit in the current access unit, the value of du_smt_cbmb_removal_delay_increment shall be equal to 0.

dbmb_output_du_delay_present_flag equal to 1 specifies the presence of the bm_smt_dpb_output_du_delay syntax element in the decoding unit information SEI message. dbmb_output_du_delay_present_flag equal 0 to specifies the absence of the bm_smt_dbmb_output_du_delay syntax element in the decoding unit information SEI message.

bm_smt_dbmb_output_du_delay is used to compute the DBMB output time of the basemesh when SubMeshHrdFlag is equal to 1. It specifies how many sub clock ticks to wait after removal of the last decoding unit in an access unit from the CBMB before the decoded submesh is output from the DBMB. When not present, the value of bm_smt_dbmb_output_du_delay is inferred to be equal to bm_dbmb_output_du_delay.

The length of the syntax element bm_smt_dbmb_output_du_delay is given in bits by dbmb_output_delay_du_length_minus1+1.

When the buffering period SEI message is non-scalable-nested or is directly contained in a scalable nesting SEI message within an SEI NAL unit with bmesh_nal_layer_id equal to 0, it is a requirement of bitstream conformance that all decoding unit information SEI messages that are associated with the same access unit, apply to the same operation point, and have dbmb_output_du_delay_present_flag equal to 1 shall have the same value of bm_smt_dbmb_output_du_delay.

The output time derived from the bm_smt_dbmb_output_du_delay of any basemesh that is output from an output timing conforming decoder shall precede the output time derived from the bm_smt_dbmb_output_du_delay of all subeshes in any subsequent CBMS in decoding order.

The basemesh output order established by the values of this syntax element shall be the same order as established by the values of FrmOrderCntVal.

For basemeshes that are not output by the “bumping” process because they precede, in decoding order, an IRAP basemesh with NoRasIOutputFlag equal to 1 that has NoOutputOfPriorBmsFlag equal to 1, the output times derived from bm_smt_dbmb_output_du_delay shall be increasing with increasing value of FrmOrderCntVal relative to all basemeshes within the same CBMS.

For any two basemeshes in the CBMS, the difference between the output times of the two basemeshes when SubMeshHrdFlag is equal to 1 shall be identical to the same difference when SubMeshHrdFlag is equal to 0.

### H.12 Basemesh Hypothetical Reference Decoder

This clause specifies the hypothetical reference decoder (HRD) and its use to check basemesh bitstream and decoder conformance.

Two types of bitstreams or bitstream subsets are subject to HRD conformance checking for this Specification. The first type, called a Type I bitstream, is a BNAL unit stream containing only the BMCL NAL units and non-BMCL NAL units with bmesh_nal_unit_type equal to BNAL FD (filler data NAL units) for all coded basemesh access units in the bitstream. The second type, called a Type II bitstream, contains additional non-BMCL NAL units other than filler data NAL units in addition to the BMCL units and filler data NAL units for all coded basemesh access units in the basemesh bitstream.

FIG. 6 shows a structure of BNAL unit streams for HRD conformance checks according to some embodiments.

The syntax elements of non-BMCL NAL units (or their default values for some of the syntax elements), required for the HRD, are specified in the semantic subclauses of Annex H.

Two types of HRD parameter sets (BNAL HRD parameters and BMCL HRD parameters) are used. The HRD parameter sets are signalled through the bmhrd_parameters( ) syntax structure, which may be part of the BM SPS syntax structure.

Two sets of bitstream conformance tests are needed for checking the conformance of a bitstream, which is referred to as the entire bitstream, denoted as entireBitstream. The first set of bitstream conformance tests are for testing the conformance of the entire bitstream and its temporal subsets without including non-BMCL NAL units. The second set of the bitstream conformance tests are for testing the conformance of the entire bitstream. For all these tests, only the basemesh frames with bmesh_nal_layer_id equal to 0 are decoded when the decoding process is invoked.

For each test, the following steps apply in the order listed:
1. An operation point under test, denoted as TargetOp, is selected by selecting a target highest TemporalId value OpTid. The value of OpTid is set to 0 for basemesh HRD. The sub-bitstream BitstreamToDecode is required to satisfy both of the following conditions:

There is at least one BMCL NAL unit in BitstreamToDecode with bmesh_nal_layer_id equal to 0.

There is at least one BMCL NAL unit with TemporalId equal to OpTid in BitstreamToDecode.
2. HighestTid is set equal to OpTid of TargetOp.
3. The bm_hrd_parameters( ) syntax structure applicable to TargetOp is selected. Within the selected bm_hrd_parameters( ) syntax structure, if BitstreamToDecode is a Type I bitstream, the sub_layer_hrd_parameters(HighestTid) syntax structure that immediately follows the condition “if (hrd_bmcl_parameters_present_flag)” is selected and the variable NalHrdModeFlag is set equal to 0; otherwise (BitstreamT oDecode is a Type II bitstream), the sub_layer_hrd_parameters(HighestTid) syntax structure that immediately follows either the condition “if (hrd_bmcl_parameters_present_flag)” (in this case the variable NalHrdModeFlag is set equal to 0) or the condition “if (hrd_nal_parameters_present_flag)” (in this case the variable NalHrdModeFlag is set equal to 1) is selected. When BitstreamToDecode is a Type II bitstream and NalHrdModeFlag is equal to 0, all non-BMCL NAL units except filler data NAL units, when present, are discarded from BitstreamToDecode and the remaining bitstream is assigned to BitstreamToDecode.
4. A coded basemesh access unit associated with a buffering period SEI message (present in BitstreamToDecode or available through external means not specified in this Specification) applicable to TargetOp is selected as the basemesh HRD initialization point and referred to as coded basemesh access unit 0.
5. For each coded basemesh access unit in BitstreamToDecode starting from coded basemesh access unit 0, the buffering period SEI message (present in BitstreamToDecode or available through external means not specified in this document) that is associated with the coded basemesh access unit and applies to TargetOp is selected, the basemesh frame timing SEI message (present in BitstreamToDecode or available through external means not specified in this document) that is associated with the coded access unit and applies to TargetOp is selected.
6. A value of SchedSelIdx is selected. The selected SchedSelIdx shall be in the range of 0 to cbmb_cnt_minus1, inclusive, where comb_cnt_minus1 is found in the bmhrd_parameters( ) syntax structure.
7. When the coded basemesh frame in coded basemesh access unit 0 has bmesh_nal_unit_type equal to BNAL_CRA or BNAL_BLA_W_LP and irap_cbmb_params_present_flag in the selected buffering period SEI message is equal to 1, either of the following applies for selection of the initial CBMB removal delay and delay offset:

If NalHrdModeFlag is equal to 1, the default initial CBMB removal delay and delay offset represented by nal_initial_cbmb_removal_delay[SchedSelIdx] and nal_initial_cbmb_removal_offset[SchedSelIdx], respectively, in the selected buffering period SEI message are selected. Otherwise, the default initial CBMB removal delay and delay offset represented by bmcl_initial_cbmb_removal_delay[SchedSelIdx] and bmcl_initial_cbmb_removal_offset[SchedSelIdx], respectively, in the selected buffering period SEI message are selected. The variable DefaultlnitCbmbParamsFlag is set equal to 1.

If NalHrdModeFlag is equal to 1, the alternative initial CBMB removal delay and delay offset represented by nal_initial_alt_cbmb_removal_delay[SchedSelIdx] and nal_initial_alt_cbmb_removal_offset[SchedSelIdx], respectively, in the selected buffering period SEI message are selected. Otherwise, the alternative initial CBMB removal delay and delay offset represented by bmcl_initial_alt_cbmb_removal_delay[SchedSelIdx] and bmcl_initial_alt_cbmb_removal_offset[SchedSelIdx], respectively, in the selected buffering period SEI message are selected. The variable DefaultInitCbmbParamsFlag is set equal to 0, and the RASL coded basemesh access units associated with coded basemesh access unit 0 are discarded from BitstreamToDecode and the remaining bitstream is assigned to BitstreamToDecode.

Each conformance test includes a combination of one option in each of the above steps. When there is more than one option for a step, for any particular conformance test only one option is chosen. All possible combinations of all the steps form the entire set of conformance tests.

For each operation point under test, the number of bitstream conformance tests to be performed is equal to n0*n1*(n2*2+n3)*n4, where the values of n0, n1, n2, n3, and n4 are specified as follows:
n0 is equal to 1 whether BitstreamToDecode is a Type I or Type II bitstream.
n1 is equal to comb_cnt_minus1+1.
n2 is the number of coded basemesh access units in BitstreamToDecode that each is associated with a buffering period SEI message applicable to TargetOp and for each of which both of the following conditions are true:
bmesh_nal_unit_type is equal to BNAL_CRA or BNAL_BLA_W_LP for the BMCL NAL units.

The associated buffering period SEI message applicable to TargetOp has irap_cbmb_params_present_flag equal to 1.

n3 is the number of coded basemesh access units in BitstreamToDecode that each is associated with a buffering period SEI message applicable to TargetOp and for each of which one or both of the following conditions are true:

bmesh_nal_unit_type is equal to neither BNAL_CRA nor BNAL_BLA_W_LP for the BMCL NAL units.

The associated buffering period SEI message applicable to TargetOp has irap_cbmb_params_present_flag equal to 0. n4 is equal to 1.

When BitstreamToDecode is a Type II bitstream, the following applies:

If the sub_layer_hrd_parameters(HighestTid) syntax structure that immediately follows the condition “if (bmcl_hrd_parameters_present_flag)” is selected, the test is conducted at the Type I conformance point shown in FIG. 6, and only BMCL and filler data NAL units are counted for the input bit rate and CBMB storage.

Otherwise (the sub_layer_hrd_parameters(HighestTid) syntax structure that immediately follows the condition “if (bnal_hrd_parameters_present_flag)” is selected), the test is conducted at the Type II conformance point shown in FIG. 6, and all bytes of the Type II bitstream, which is a BNAL unit stream, are counted for the input bit rate and CBMB storage.

BNAL HRD parameters established by a value of SchedSelIdx for the Type II conformance point shown in FIG. 6 are sufficient to also establish BMCL HRD conformance for the Type I conformance point shown in FIG. 6 for the same values of InitCbmbRemovalDelay[SchedSelIdx], BitRate[SchedSelIdx] and CbmbSize[SchedSelIdx] for the variable bit rate (VBR) case (cbr_flag[SchedSelIdx] equal to 0). This is because the data flow into the Type I conformance point is a subset of the data flow into the Type II conformance point and because, for the VBR case, the CBMB is allowed to become empty and stay empty until the time a next basemesh frame is scheduled to begin to arrive.

All BM SPSs and BM FPSs referred to in the BMCL NAL units and the corresponding buffering period, basemesh frame timing SEI messages shall be conveyed to the HRD, in a timely manner, either in the bitstream (by non-BMCL NAL units), or by other means not specified in this document.

In clause H.12, Annexes F and G, the specification for “presence” of non-BMCL NAL units that contain BM SPSs, BM FPSs, buffering period SEI messages, or basemesh frame timing SEI messages is also satisfied when those BNAL units (or just some of them) are conveyed to basemesh decoders (or to the HRD) by other means not specified in this document. For the purpose of counting bits, only the appropriate bits that are actually present in the basemesh sub-bitstream are counted.

As an example, synchronization of such a non-BMCL NAL unit, conveyed by means other than presence in the bitstream, with the BNAL units that are present in the bitstream, can be achieved by indicating two points in the bitstream, between which the non-BMCL NAL unit would have been present in the bitstream, had the encoder decided to convey it in the bitstream. When the content of such a non-BMCL NAL unit is conveyed for the application by some means other than presence within the bitstream, the representation of the content of the non-BMCL NAL unit is not required to use the same syntax as specified in this document.

When HRD information is contained within the bitstream, it is possible to verify the conformance of a bitstream to the requirements of this clause based solely on information contained in the bitstream. When the HRD information is not present in the bitstream, as is the case for all “stand-alone” Type I bitstreams, conformance can be verified when the HRD data are supplied by some other means not specified in this document.

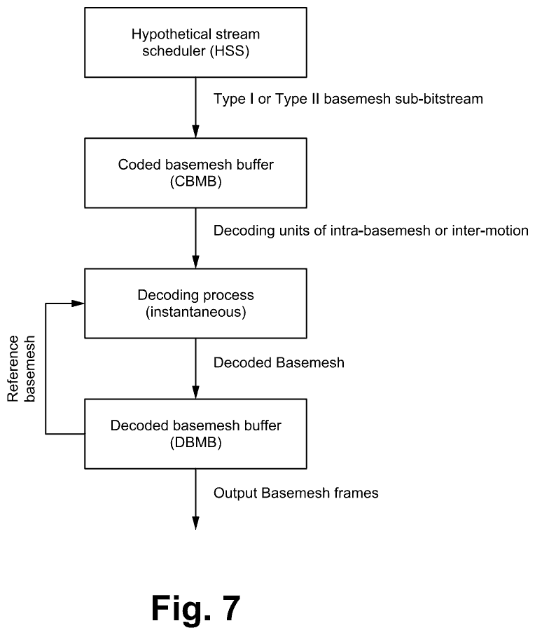

The HRD contains a coded basemesh frame buffer (CBMB), an instantaneous decoding process, and a decoded basemesh frame buffer (DBMB) as shown in FIG. 7.

FIG. 7 shows a basemesh HRD buffer model according to some embodiments.

For each bitstream conformance test, the CBMB size (number of bits) is CbmbSize[SchedSelIdx] as specified in clause G.3.3 (sub-layer HRD parameters semantics), where SchedSelIdx and the basemesh HRD parameters are specified in this clause. The DBMB size (number of basemesh frame storage buffers) is bmsps_max_dec_bmfr_buffering_minus1[HighestTid]+1.

The following is specified for expressing the constraints in this annex:

Each coded basemesh access unit is referred to as coded basemesh access unit n, where the number n identifies the particular coded basemesh access unit. Coded basemesh access unit 0 is selected per step 4 above. The value of n is incremented by 1 for each subsequent coded basemesh access unit in decoding order.

Each decoding unit is referred to as decoding unit m, where the number m identifies the particular decoding unit. The first decoding unit in decoding order in access unit 0 is referred to as decoding unit 0. The value of m is incremented by 1 for each subsequent decoding unit in decoding order.

Basemesh frame n refers to the coded basemesh frame or the decoded basemesh frame of coded basemesh access unit n.

The HRD operates as follows:

The HRD is initialized at decoding unit 0, with both the CBMB and the DBMB being set to be empty (the DBMB fullness is set equal to 0).

After initialization, the HRD is not initialized again by subsequent buffering period SEI messages.

Data associated with decoding units that flow into the CBMB according to a specified arrival schedule are delivered by the HSS.

The data associated with each decoding unit are removed and decoded instantaneously by the instantaneous decoding process at the CBMB removal time of the decoding unit.

Each decoded basemesh frame is placed in the DBMB.

A decoded basemesh frame is removed from the DBMB when it becomes no longer needed for inter prediction reference and no longer needed for output.

For each bitstream conformance test, the operation of the CBMB is specified in subclause H.12.2, the instantaneous decoder operation is specified in clauses H.2 through H.10, the operation of the DBMB is specified in clause H.12.3.

HSS and HRD information concerning the number of enumerated delivery schedules and their associated bit rates and buffer sizes is specified in clauses G.2.2 and G.3.2 (HRD parameters syntax and semantics). The HRD is initialized as specified by the buffering period SEI message specified in clauses F.2.X and F.3.X. The removal timing of decoding units from the CBMB and output timing of decoded basemesh frames from the DBMB is specified using information in basemesh frame timing SEI messages (specified in clauses F.2.3 and F.3.3). All timing information relating to a specific decoding unit shall arrive prior to the CBMB removal time of the decoding unit.

The requirements for bitstream conformance are specified in clause H.12.4 and the HRD is used to check conformance of bitstreams as specified in this clause and to check conformance of basemesh decoders as specified in clause H.12.5.

While conformance is guaranteed under the assumption that all basemesh frame rates and clocks used to generate the bitstream match exactly the values signalled in the bitstream, in a real system each of these may vary from the signalled or specified value.

All the arithmetic in this annex is performed with real values, so that no rounding errors can propagate. For example, the number of bits in a CBMB just prior to or after removal of a decoding unit is not necessarily an integer.

The variable ClockTick is derived as follows and is called a clock tick:

$$ClockTick = vui\_num \_units \_in \_tick \div vui\_time \_scale \qquad ( H 1 )$$

### H.12.2 Operation of Coded Basemesh Buffer (CBMB)

The specifications in this clause apply independently to each set of coded basemesh buffer (CBMB) parameters that is present and to both the Type I and Type II conformance points shown in FIG. 6 and the set of CBMB parameters is selected as specified in clause H.12.1.

### H.12.2.2 Timing of Decoding Unit Arrival

The process specified in this clause is invoked with a decoding unit being considered as a coded basemesh access unit, for derivation of the initial and final CBMB arrival times for coded basemesh access unit n.

The variables InitC bmbRemovalDelay[SchedSelIdx] and InitCbmbRemovalDelayOffset[SchedSelIdx] are derived as follows:

If one or more of the following conditions are true, InitCbmbRemovalDelay[SchedSelIdx] and InitCbmbRemovalDelayOffset[SchedSelIdx] are set equal to the values of the buffering period SEI message syntax elements bnal_initial_alt_cbmb_removal_delay[SchedSelIdx] and bnal_initial_alt_cbmb_removal_offset[SchedSelIdx], respectively, when NalHrdModeFlag is equal to 1 or bmcl_initial_alt_cbmb_removal_delay[SchedSelIdx] and bmcl_initial_alt_cbmb_removal_offset[SchedSelIdx], respectively, when NalHrdModeFlag is equal to 0, where the buffering period SEI message syntax elements are selected as specified in clause H.12.1:

Coded basemesh access unit 0 is a BLA access unit for which the coded basemesh frame has bmesh_nal_unit_type equal to BNAL_BLA_W_RADL or BNAL BLA_N_LP, and the value of irap_cbmb_params_present_flag of the buffering period SEI message is equal to 1.

Coded basemesh access unit 0 is a BLA access unit for which the coded basemesh frame has bmesh_nal_unit_type equal to BNAL_BLA_W_LP or is a BNAL_CRA access unit, and the value of irap_cbmb_params_present_flag of the buffering period SEI message is equal to 1 and one or more of the following conditions are true:

UseA ItCbmbParamsFlag for coded basemesh access unit 0 is equal to 1.

DefaultInitCbmbbParamsFlag is equal to 0.

Otherwise, InitCbmbRemovalDelay[SchedSelIdx] and InitCbmbRemoval DelayOffset[SchedSelIdx] are set equal to the values of the buffering period SEI message syntax elements bnal_initial_cbmb_removal_delay[SchedSelIdx] and bnal_initial_cbmb_removal_offset[SchedSelIdx], respectively, when NalHrdModeFlag is equal to 1, or bmcl_initial_cbmb_removal_delay[SchedSelIdx] and bmcl_initial_cbmb_removal_offset[SchedSelIdx], respectively, when NalHrdModeFlag is equal to 0, where the buffering period SEI message syntax elements are selected as specified in clause H.12.1.

The time at which the first bit of decoding unit m begins to enter the CBMB is referred to as the initial arrival time initArrivalTime[m].

The initial arrival time of decoding unit m is derived as follows:

If the decoding unit is decoding unit 0 (e.g., when m is equal to 0), initArrivalTime[0] is set equal to 0.

Otherwise (the decoding unit is decoding unit m with m>0), the following applies:

If cbr_flag[SchedSelIdx] is equal to 1, the initial arrival time for decoding unit m is equal to the final arrival time (which is derived below) of decoding unit m−1, e.g.,

$$i n i t A r r i v a l T i m e [ m ] = A u F i n a l A r r i v a l T i m e [ m - 1 ] \qquad ( H 2 )$$

Otherwise (cbr_flag[SchedSelIdx] is equal to 0), the initial arrival time for decoding unit m is derived as follows:

$$i n i t A r r i v a l T i m e [ m ] = Max ( AuFinalArrivalTime [ m - 1 ] , initArrivalEarliestTime [ m ] ) \qquad ( H 3 )$$

where initArrivalEarliestTime[m] is derived as follows:

The variable tmpNominalRemovalTime is derived as follows:

$$tmpNominalRemovalTime = AuNominalRemovalTime [ m ] \qquad ( H 4 )$$

where AuNominalRemovalTime[m] is the nominal CBMB removal time of coded basemesh access unit m as specified in H.12.2.3.

If decoding unit m is not the first decoding unit of a subsequent buffering period, initArrivalEarliestTime[m] is derived as follows:

$$initArrivalEarliestTime [ m ] = tmpNominalRemovalTime - ( InitCbmbRemovalDelay [ SchedSelIdx ] + InitCbmbRemovalDelayOffset [ SchedSelIdx ] ) \div 90000 \qquad ( H 5 )$$

Otherwise (decoding unit m is the first decoding unit of a subsequent buffering period), initArrivalEarliestTime[m] is derived as follows:

$$initArrivalEarliestTime [ m ] = tmpNominalRemovalTime - ( InitCbmbRemovalDelay [ SchedSelIdx ] \div 90000 ) \qquad ( H 6 )$$

The final arrival time for decoding unit m is derived as follows:

$$AuFinalArrivalTime [ m ] = initArrivalTime [ m ] + sizeInbits [ m ] \div BitRate [ SchedSelIdx ] \qquad ( H 7 )$$

where sizeInbits[m] is the size in bits of decoding unit m, counting the bits of the BMCL NAL units and the filler data NAL units for the Type I conformance point or all bits of the Type II bitstream for the Type II conformance point, where the Type I and Type II conformance points are as shown in FIG. 6.

The values of SchedSelIdx, BitRate[SchedSelIdx], and CbmbSize[SchedSelIdx] are constrained as follows:

If the content of the selected hrd_parameters( ) syntax structures for the coded basemesh access unit containing decoding unit m and the previous coded basemesh access unit differ, the HSS selects a value SchedSelIdx1 of SchedSelIdx from among the values of SchedSelIdx provided in the selected hrd_parameters( ) syntax structures for the coded basemesh access unit containing decoding unit m that results in a BitRate[SchedSelIdx1] or CbmbSize[SchedSelIdx1] for the coded basemesh access unit containing decoding unit m. The value of BitRate[SchedSelIdx1] or CbmbSize[SchedSelIdx1] may differ from the value of BitRate[SchedSelIdx0] or CbmbSize[SchedSelIdx0] for the value SchedSelIdx0 of SchedSelIdx that was in use for the previous coded basemesh access unit.

Otherwise, the HSS continues to operate with the previous values of SchedSelIdx, BitRate[SchedSelIdx] and CbmbSize[SchedSelIdx].

When the HSS selects values of BitRate[SchedSelIdx] or CbmbSize[SchedSelIdx] that differ from those of the previous coded basemesh access unit, the following applies:

The variable BitRate[SchedSelIdx] comes into effect at the initial CBMB arrival time of the current coded basemesh access unit.

The variable CbmbSize[SchedSelIdx] comes into effect as follows:

If the new value of CbmbSize[SchedSelIdx] is greater than the old CBMB size, it comes into effect at the initial CBMB arrival time of the current coded basemesh access unit.

Otherwise, the new value of CmbbSize[SchedSelIdx] comes into effect at the CBMB removal time of the current coded basemesh access unit.

### H.12.2.3 Timing of Decoding Unit Removal and Decoding of Decoding Unit

The variables InitCbmbRemovalDelay[SchedSelIdx], InitCbmbRemoval DelayOffset[SchedSelIdx], CbmbDelayOffset, and DbmbDelayOffset are derived as follows:

If one or more of the following conditions are true, CbmbDelayOffset is set equal to the value of the buffering period SEI message syntax element cbmb_delay_offset, DbmbDelayOffset is set equal to the value of the buffering period SEI message syntax element dbmb_delay_offset, and InitCbmbRemovalDelay[SchedSelIdx] and InitCbmbRemovalDelayOffset[SchedSelIdx] are set equal to the values of the buffering period SEI message syntax elements bnal_initial_alt_cbmb_removal_delay[SchedSelIdx] and bnal_initial_alt_cbmb_removal_offset[SchedSelIdx], respectively, when NalHrdModeFlag is equal to 1, or bmcl_initial_alt_cpb_removal_delay[SchedSelIdx] and bmcl_initial_alt_cpb_removal_offset[SchedSelIdx], respectively, when NalHrdModeFlag is equal to 0, where the buffering period SEI message containing the syntax elements is selected as specified in H.12.1:
Coded basemesh access unit 0 is a BLA access unit for which the coded basemesh frame has bmesh_nal_unit_type equal to BNAL_BLA_W_RADL or BNAL BLA_N_LP, and the value of irap_cbmb_params_present_flag of the buffering period SEI message is equal to 1.
Coded basemesh access unit 0 is a BLA access unit for which the coded basemesh frame has bmesh_nal_unit_type equal to BNAL_BLA_W_LP or is a CRA access unit, and the value of irap_cbmb_params_present_flag of the buffering period SEI message is equal to 1, and one or more of the following conditions are true:
UseAItCbmbParamsFlag for coded basemesh access unit 0 is equal to 1.
DefaultInitCbmbParamsFlag is equal to 0.

Otherwise, InitCbmbRemovalDelay[SchedSelIdx] and InitCbmbRemovalDelayOffset[SchedSelIdx] are set equal to the values of the buffering period SEI message syntax elements bnal_initial_cbmb_removal_delay[SchedSelIdx] and bnal_initial_cbmb_removal_offset[SchedSelIdx], respectively, when NalHrdModeFlag is equal to 1, or bmcl_initial_cbmb_removal_delay[SchedSelIdx] and bmcl_initial_cpb_removal_offset[SchedSelIdx], respectively, when NalHrdModeFlag is equal to 0, where the buffering period SEI message containing the syntax elements is selected as specified in H.12.1, CbmbDelayOffset and DbmbDelayOffset are both set equal to 0.

The nominal removal time of the coded basemesh access unit n from the CBMB is specified as follows:

If coded basemesh access unit n is the coded basemesh access unit with n equal to 0 (the access unit that initializes the HRD), the nominal removal time of the coded basemesh access unit from the CBMB is specified by:

$$AuNominalRemovalTime [ 0 ] = InitCbmbRemovalDelay [ SchedSelIdx ] \div 90000 \qquad ( H 8 )$$

Otherwise, the following applies:

When coded basemesh access unit n is the first access unit of a buffering period that does not initialize the HRD, the following applies:

The nominal removal time of the coded basemesh access unit n from the CBMB is specified by:

```
if( !concatenationFlag ) {
  baseTime = AuNominalRemovalTime[ firstPicInPrevBuffPeriod ]
  tmpCbmbRemovalDelay = AuCbmbRemovalDelayVal
} else {
  baseTime = AuNominalRemovalTime[ prevNonDiscardablePic ]
  tmpCbmbRemovalDelay =
```

| | |
|---|---|
| Max( ( auCbmbRemovalDelayDeltaMinus1 + 1 ), | (H 9) |

```
      Ceil( ( InitCbmbRemovalDelay[ SchedSelIdx ] ÷ 90000 +
        AuFinalArrivalTime[ n − 1 ] − AuNominalRemovalTime[ n − 1 ] ) ÷
ClockTick ) )
}
AuNominalRemovalTime[ n ] = baseTime + ClockTick * ( tmpCbmbRemovalDelay −
CbmbDelayOffset )
```

where AuNominalRemovalTime[firstPicInPrevBuffPeriod] is the nominal removal time of the first coded basemesh access unit of the previous buffering period, AuNominalRemovalTime[prevNonDiscardablePic] is the nominal removal time of the preceding coded basemesh access unit in decoding order with TemporalId equal to 0 that is not a RASL, RADL, or SLNR basemesh frame, AuCbmbRemovalDelayVal is the value of AuCbmbRemovalDelayVal derived according to au_cbmb_removal_delay_minus1 in the basemesh frame timing SEI message, selected as specified in H.12.1, associated with coded basemesh access unit n, and concatenationFlag and auCbmbRemovalDelayDeltaMinus1 are the values of the syntax elements concatenation_flag and au_cbmb_removal_delay_delta_minus1, respectively, in the buffering period SEI message, selected as specified in H.12.1, associated with coded basemesh access unit n.

After the derivation of the nominal CBMB removal time and before the derivation of the DBMB output time of coded basemesh access unit n, the values of CbmbDelayOffset and DbmbDelayOffset are updated as follows:
If one or more of the following conditions are true, CbmbDelayOffset is set equal to the value of the buffering period SEI message syntax element cbmb_delay_offset, and DbmbDelayOffset is set equal to the value of the buffering period SEI message syntax element dbmb_delay_offset, where the buffering period SEI message containing the syntax elements is selected as specified in H.12.1:
Coded basemesh access unit n is a BLA access unit for which the coded basemesh frame has bmesh_nal_unit_type equal to BNAL_BLA_W_RADL or BNAL_BLA_N_LP, and the value of irap_cbmb_params_present_flag of the buffering period SEI message is equal to 1.
Coded basemesh access unit n is a BLA access unit for which the coded basemesh frame has bmesh_nal_unit_type equal to BNAL_BLA_W_LP or is a CRA access unit, and the value of irap_cbmb_params_present_flag of the buffering period SEI message is equal to 1, and UseAItCbmbParamsFlag for coded basemesh access unit n is equal to 1.

Otherwise, CbmbDelayOffset and DbmbDelayOffset are both set equal to 0.

When coded basemesh access unit n is not the first coded basemesh access unit of a buffering period, the nominal removal time of the coded basemesh access unit n from the CBMB is specified by:

$$AuNominalRemovalTime [ n ] = AuNominalRemovalTime [ firstBasemeshInCurrBuffPeriod ] + ClockTick * ( AuCbmbRemovalDelayVal - CbmbDelayOffset ) \qquad ( H 10 )$$

where AuNominalRemovalTime[firstBasemeshInCurrBuffPeriod] is the nominal removal time of the first coded basemesh access unit of the current buffering period, and AuCbmbRemovalDelayVal is derived according to au_cbmb_removal_delay_minus1 in the basemesh timing SEI message, selected as specified in H.12.1, associated with coded basemesh access unit n.

At the CBMB removal time of coded basemesh access unit n, the coded basemesh access unit is instantaneously decoded.

### H.12.3 Operation of the Decoded Basemesh Buffer (DBMB)

The specifications in this clause apply independently to each set of DBMB parameters selected as specified in H.12.1.

The decoded basemesh buffer contains basemesh frame storage buffers. Each of the basemesh frame storage buffers may contain a decoded basemesh frame that is marked as “used for reference” or is held for future output. The processes specified in H.12.3.2, H.12.3.3, H.12.3.4, and H.12.3.5 are sequentially applied as specified below.

H.12.3.2 Removal of Basemesh Frame from the DBMB Before Decoding of the Current Basemesh Frame

The removal of basemesh frame from the DBMB before decoding of the current basemesh frame (but after parsing the submesh header of the first submesh of the current basemesh frame) happens instantaneously at the CBMB removal time of the first decoding unit of coded basemesh access unit n (containing the current basemesh frame) and proceeds as follows:

The reference mesh frame list construction process as specified in H.9.4.3, followed by the reference mesh frame marking process as specified in H.9.4.4 are invoked.

When the current basemesh frame is an IRAP basemesh frame with NoOutputBeforeRecoveryFlag equal to 1 that is not basemesh frame 0, the following ordered steps are applied:
1. The variable NoOutputOfPriorMeshFramesFlag is derived for the decoder under test as follows:
   If the current basemesh frame is a CRA basemesh frame, NoOutputOfPriorMeshFramesFlag is set equal to 1 (regardless of the value of bmsh_no_output_of_prior_mesh_frames_flag).
   Otherwise, if the value of bmsps_geometry_3d_bit_depth_minus1, bmsps_mesh_attribute_dimension_minus1, bmsps_attribute_bit_depth_minus1, or bmsps_max_dec_mesh_frame_buffering_minus1 derived from the active Basemesh SPS is different from the value of bmsps_geometry_3d_bit_depth_minus1, bmsps_mesh_attribute_dimension_minus1, bmsps_attribute_bit_depth_minus1, or bmsps_max_dec_mesh_frame_buffering_minus1, respectively, derived from the Basemesh SPS active for the preceding basemesh frame, NoOutputOfPriorMeshFramesFlag may (but should not) be set to 1 by the basemesh decoder under test, regardless of the value of bmsh_no_output_of_prior_mesh_frames_flag.
   Although setting NoOutputOfPriorMeshFramesFlag equal to bmsh_no_output_of_prior_mesh_frames_flag is preferred under these conditions, the basemesh decoder under test can set NoOutputOfPriorMeshFramesFlag to 1 in this case.
   Otherwise, NoOutputOfPriorMeshFramesFlag is set equal to bmsh_no_output_of_prior_mesh_frames_flag.
2. The value of NoOutputOfPriorMeshFramesFlag derived for the basemesh decoder under test is applied for the HRD, such that when the value of NoOutputOfPriorMeshFramesFlag is equal to 1, all basemesh frame storage buffers in the DBMB are emptied without output of the basemesh frames they contain, and the DBMB fullness is set equal to 0.
   When both of the following conditions are true for any basemesh frames k in the DBMB, all such basemesh frames k in the DBMB are removed from the DBMB:
   basemesh frame k is marked as “unused for reference”
   basemesh frame k has MeshFrameOutputFlag equal to 0 or its DBMB output time is less than or equal to the CBMB removal time of the first decoding unit (denoted as decoding unit m) of the current basemesh frame n, e.g., DbmbOutputTime[k] is less than or equal to AuCbmbRemovalTime[m]

For each basemesh frame that is removed from the DBMB, the DBMB fullness is decremented by one.

### H.12.3.3 Basemesh Frame Output

The processes specified in this clause happen instantaneously at the CBMB removal time of coded basemesh access unit n, AuCbmbRemovalTime[n].

When basemesh frame n has MeshFrameOutputFlag equal to 1, its DBMB output time DbmbOutputTime[n] is derived as follows, where the variable firstMeshFramelnBufferingPeriodFlag is equal to 1 if coded basemesh access unit n is the first coded basemesh access unit of a buffering period and 0 otherwise:

$$DbmbOutputTime [ n ] = A u C b m b R e movalTime [ n ] + ClockTick * meshFrameDbmbOutputDelay \qquad ( H 11 )$$

$$if ( firstMeshFrameInBufferingPeriodFlag )$$

$$DbmbOutTime [ n ] -= ClockTick * DbmbDelayOffset ,$$

where meshFrameD bmbOutputDelay is the value of mesh_frame_dbmb_output_delay in the basemesh frame timing SEI message associated with coded basemesh access unit n.

The output of the current basemesh frame is specified as follows:

If MeshFrameOutputFlag is equal to 1 and DbmbOutputTime[n] is equal to AuCbmbRemovalTime[n], the current basemesh frame is output.

Otherwise, if MeshFrameOutputFlag is equal to 0, the current basemesh frame is not output, but will be stored in the DBMB as specified in H.12.3.4.

Otherwise (MeshFrameOutputFlag is equal to 1 and DbmbOutputTime[n] is greater than AuCbmbRemovalTime[n]), the current basemesh frame is output later and will be stored in the DBMB (as specified in H.12.3.4) and is output at time D bmbOutputTime[n] unless indicated not to be output by the decoding or inference of bmsh_no_output_of_prior_mesh_frames_flag equal to 1 at a time that precedes DbmbOutputTime[n].

When basemesh frame n is a basemesh frame that is output and is not the last basemesh frame of the bitstream that is output, the value of the variable D bmbOutputInterval[n] is derived as follows:

$$DbmbOutputInterval [ n ] = DbmbOutputTime [ nextMeshFrameInOutputOrder ] - DbmbOutputTime [ n ] \qquad ( H 12 )$$

where nextMeshFramel nOutputOrder is the basemesh frame that follows basemesh frame n in output order and has MeshFrameOutputFlag equal to 1.

### H.12.3.4 Current Decoded Basemesh Frame Marking and Storage

The current decoded basemesh frame is stored in the DBMB in an empty basemesh frame storage buffer and the DBMB fullness is incremented by one. When bmsps_long_term_ref_mesh_frames_flag is equal to 1, this basemesh frame is marked as “used for long-term reference”. After all the submeshes of the current basemesh frame have been decoded, this basemesh frame is marked as “used for short-term reference”.

Unless more memory than required by the level limit is available for storage of decoded basemesh frames, decoders should start storing decoded parts of the current basemesh frame into the DBMB when the first submesh is decoded and continue storing more decoded basemesh data as the decoding process proceeds.

### H.12.4 Bitstream Conformance

A bitstream of coded data conforming to this document shall fulfill the requirements specified in this clause.

The bitstream shall be constructed according to the syntax, semantics, and constraints specified in this document.

The first coded basemesh access unit in a bitstream shall be an IRAP coded basemesh frame, e.g., an IDR basemesh frame, a CRA basemesh frame or a BLA basemesh frame.

The bitstream is tested by the HRD for conformance as specified in H.12.1.

For each current basemesh frame, let the variables maxMeshFrmOrderCnt and minMeshFrmOrderCnt be set equal to the maximum and the minimum, respectively, of the MeshFrmOrderCntVal values of the following basemesh frames:

The current basemesh frame.

The previous basemesh frame in decoding order that has TemporalId equal to 0 and that is not a RASL, RADL, or SLNR basemesh frame.

The short-term reference basemesh frames in the reference mesh frame list of the current basemesh frame.

All basemesh frames n that have MeshFrameOutputFlag equal to 1, AuCbmbRemovalTime[n] less than AuCbmbRemovalTime[currMeshFrm], and DbmbOutputTime[n] greater than or equal to AuCbmbRemovalTime[currMeshFrm], where currMeshFrm is the current basemesh frame.

The following conditions are fulfilled for each of the bitstream conformance tests:
1. For each coded basemesh access unit n, with n greater than 0, associated with a buffering period SEI message, let the variable deltaTime90k[n] be specified as follows:

$$d e l t a T i m e 90 k [ n ] = 90000 * ( AuNominalRemovalTime [ n ] - AuFinalArrivalTime [ n - 1 ] ) \qquad ( H 13 )$$

The value of InitC bmbRemovalDelay [SchedSelIdx] is constrained as follows:
If cbr_flag[SchedSelIdx] is equal to 0, the following condition shall be true:

$$InitCbmbRemovalD e lay [ SchedSelIdx ] <= Ceil ( deltaTime 90 k [ n ] ) \qquad ( H 14 )$$

Otherwise (cbr_flag[SchedSelIdx] is equal to 1), the following condition shall be true:

$$Floor ( deltaTime 90 k [ n ] ) <= InitCpbRemovalDelay [ SchedSelIdx ] <= Ceil ( deltaTime 90 k [ n ] ) \qquad ( H 15 )$$

The exact number of bits in the CBMB at the removal time of each basemesh frame may depend on which buffering period SEI message is selected to initialize the HRD. Encoders must take this into account to ensure that all specified constraints must be obeyed regardless of which buffering period SEI message is selected to initialize the HRD, as the HRD may be initialized at any one of the buffering period SEI messages.
2. A CBMB overflow is specified as the condition in which the total number of bits in the CBMB is greater than the CBMB size. The CBMB shall never overflow.
3. When low_delay_hrd_flag[HighestTid] is equal to 0, the CBMB shall never underflow. A CBMB underflow is specified as follows:

A CBMB underflow is specified as the condition in which the nominal CBMB removal time of coded basemesh access unit n A uNominalRemovalTime[n] is less than the final CBMB arrival time of coded basemesh access unit n AuFinalArrivalTime[n] for at least one value of n.
4. The nominal removal times of basemesh frames from the CBMB (starting from the second basemesh frame in decoding order) shall satisfy the constraints on AuNominalRemovalTime[n] and AuCbmbRemovalTime[n] expressed in subclause H.11.
5. For each current basemesh frame, after invocation of the process for removal of basemesh frames from the DBMB as specified in H.12.3.2, the number of decoded basemesh frames in the DBMB, including all basemesh frames n that are marked as “used for reference”, or that have MeshFrameOutputFlag equal to 1 and AuCbmbRemovalTime[n] less than AuCbmbRemovalTime[currMeshFrm], where currMeshFrm is the current basemesh frame, shall be less than or equal to bmsps_max_dec_mesh_frame_buffering_minus1.
6. All reference basemesh frames shall be present in the DBMB when needed for prediction. Each basemesh frame that has MeshFrameOutputFlag equal to 1 shall be present in the DBMB at its DBMB output time unless it is removed from the DBMB before its output time by one of the processes specified in H.12.3.
7. For each current basemesh frame that is not an IRAP basemesh frame with NoOutputBeforeRecoveryFlag equal to 1, the value of maxMeshFrmOrderCnt-minMeshFrmOrderCnt shall be less than MaxMeshFrmOrderCntL sb/2.
8. The value of DbmbOutputInterval[n] as given by Formula (H 12), which is the difference between the output time of a basemesh frame and that of the first basemesh frame following it in output order and having MeshFrameOutputFlag equal to 1, shall satisfy the constraint expressed in subclause H.11 for the profile, tier and level specified in the bitstream using the decoding process specified in subclause H.9.
9. For any two basemesh frames m and n in the same CBMS, when DbmbOutputTime[m] is greater than DbmbOutputTime[n], the MeshFrmOrderCntVal of basemesh frame m shall be greater than the MeshFrmOrderCntVal of basemesh frame n.

All basemesh frames of an earlier CBMS in decoding order that are output are output before any basemesh frames of a later CB MS in decoding order. Within any particular CBMS, the basemesh frames that are output are output in increasing MeshFrmOrderCntVal order.

### H.12.5 Decoder Conformance

A decoder conforming to this document shall fulfill the limitations specified in this subclause.

A decoder claiming conformance to a specific profile, tier and level shall be able to successfully decode all bitstreams that conform to the bitstream conformance requirements specified in H.12.4, in the manner specified in H.11, provided that all BM SPSs and BM FPSS referred to in the BMCL NAL units, and appropriate buffering period and basemesh frame timing SEI messages are conveyed to the decoder, in a timely manner, either in the bitstream (by non-BMCL NAL units), or by external means not specified.

When a basemesh sub-bitstream contains syntax elements that have values that are specified as reserved and it is specified that decoders shall ignore values of the syntax elements or NAL units containing the syntax elements having the reserved values, and the basemesh sub-bitstream is otherwise conforming to this document, a conforming decoder shall decode the basemesh sub-bitstream in the same manner as it would decode a conforming basemesh sub-bitstream and shall ignore the syntax elements or the NAL units containing the syntax elements having the reserved values as specified.

There are two types of conformance that can be claimed by a decoder: output timing conformance and output order conformance.

To check conformance of a decoder, test bitstreams conforming to the claimed profile, tier and level, as specified in H.12.4 are delivered by a hypothetical basemesh frame stream scheduler (HSS) both to the HRD and to the basemesh decoder under test (DUT). All decoded basemesh frames output by the HRD shall also be output by the DUT, each decoded basemesh frame output by the DUT shall be a basemesh frame with MeshFrameOutputFlag equal to 1, and, for each such decoded basemesh frame output by the DUT, the information associated with all submeshes that are output shall be equal to the information associated with all submeshes produced by the specified decoding process.

For output timing decoder conformance, the HSS operates as described above, with delivery schedules selected only from the subset of values of SchedSelIdx for which the bit rate and CBMB size are restricted as specified in subclause H.11 for the specified profile, tier and level, or with “interpolated” delivery schedules as specified below for which the bit rate and CBMB size are restricted as specified in subclause H.11. The same delivery schedule is used for both the HRD and the DUT.

When the HRD parameters and the buffering period SEI messages are present with cbmb_cnt_minus1[HighestTid] greater than 0, the basemesh frame decoder shall be capable of decoding the basemesh sub-bitstream as delivered from the HSS operating using an “interpolated” delivery schedule specified as having peak bit rate r, CBMB size c(r), and initial CBMB removal delay (f(r)÷r) as follows:

$$α = ( r - BitRate [ SchedSelIdx - 1 ] \div ( BitRate [ SchedSelIdx ] - BitRate [ SchedSelIdx - 1 ] ) , \qquad ( H 16 )$$

$$c ( r ) = α * CbmbSize [ SchedSelIdx ] + ( 1 - α ) * CbmbSize [ SchedSelIdx - 1 ] , \qquad ( H 17 )$$

$$f ( r ) = α * InitCbmbRemovalDelay [ SchedSelIdx ] * BitRate [ SchedSelIdx ] + ( 1 - α ) * InitCbmbRemovalDelay [ SchedSelIdx - 1 ] * BitRate [ SchedSelIdx - 1 ] \qquad ( H 18 )$$

for any SchedSelIdx>0 and r such that BitRate[SchedSelIdx−1]<=r<=BitRate[SchedSelIdx] such that r and c(r) are within the limits as specified in subclause H.11 for the maximum bit rate and buffer size for the specified profile, tier and level.

InitCbmbRemovalDelay [SchedSelIdx] can be different from one buffering period to another and have to be re-calculated.

For output timing decoder conformance, an HRD as described above is used and the timing (relative to the delivery time of the first bit) of basemesh frame output is the same for both the HRD and the DUT up to a fixed delay.

For output order decoder conformance, the following applies:

The HSS delivers the bitstream BitstreamToDecode to the DUT “by demand” from the DUT, meaning that the HSS delivers bits (in decoding order) only when the DUT requires more bits to proceed with its processing.

This means that for this test, the coded basemesh buffer of the DUT could be as small as the size of the largest decoding unit.

A modified HRD as described below is used, and the HSS delivers the bitstream to the HRD by one of the schedules specified in the bitstream BitstreamToDecode such that the bit rate and CBMB size are restricted as specified in subclause H.11. The order of basemesh frames output shall be the same for both the HRD and the DUT.

The HRD CBMB size is given by CbmbSize[SchedSelIdx] as specified in H.14.2.2, where SchedSelIdx and the HRD parameters are selected as specified in H.12.1. The DBMB size is given by bmsps_max_dec_mesh_frame_buffering_minus1+1. Removal time from the CBMB for the HRD is the final bit arrival time and decoding is immediate. The operation of the DBMB of this HRD is as described in H.12.5.2 through H.12.5.2.3.

### H.12.5.2 Operation of the Output Order DBMB

The decoded basemesh buffer contains basemesh frame storage buffers. Each of the basemesh frame storage buffers contains a decoded basemesh frame that is marked as “used for reference” or is held for future output. The process for output and removal of basemesh frames from the DBMB before decoding of the current basemesh frame as specified in H.12.5.2.2 is invoked, the invocation of the process for current decoded basemesh frame marking and storage as specified in H.12.3.4, and finally followed by the invocation of the process for additional bumping as specified in H.12.5.2.3. The “bumping” process is specified in H.12.5.2.4 and is invoked as specified in H.12.5.2.2 and H.12.5.2.3.

H. 12.5.2.2 Output and Removal of Basemesh Frames from the DBMB

The output and removal of basemesh frames from the DBMB before the decoding of the current basemesh frame (but after parsing the submesh header of the first submesh of the current basemesh frame) happens instantaneously when the first decoding unit of the coded basemesh access unit containing the current basemesh frame is removed from the CBMB and proceeds as follows:

The decoding process for RAFL as specified in H.9.4.3 is invoked.
If the current basemesh frame is an IRAP coded basemesh frame with NoOutputOfPriorMeshFramesFlag equal to 1 that is not basemesh frame 0, the following ordered steps are applied:
1. The variable NoOutputOfPriorMeshFramesFlag is derived for the decoder under test as follows:
   If the current basemesh frame is a CRA basemesh frame, NoOutputOfPriorMeshFramesFlag is set equal to 1 (regardless of the value of bmsh_no_output_of_prior_mesh_frames_flag).
   Otherwise, if the value of bmsps_geometry_3d_bit_depth_minus1, bmsps_mesh_attribute_dimension_minus1, bmsps_attribute_bit_depth_minus1, or bmsps_max_dec_mesh_frame_buffering_minus1 derived for the current basemesh frame is different from the value of bmsps_geometry_3d_bit_depth_minus1, bmsps_mesh_attribute_dimension_minus1, bmsps_attribute_bit_depth_minus1, or bmsps_max_dec_mesh_frame_buffering_minus1, respectively, derived from the Basemesh SPS active for the preceding basemesh frame, NoOutputOfPriorMeshFramesFlag may (but should not) be set to 1 by the decoder under test, regardless of the value of bmsh_no_output_of_prior_mesh_frames_flag.
   Although setting NoOutputOfPriorMeshFramesFlag equal to bmsh_no_output_of_prior_mesh_frames_flag is preferred under these conditions, the decoder under test is allowed to set NoOutputOfPriorMeshFramesFlag to 1 in this case.
   Otherwise, NoOutputOfPriorMeshFramesFlag is set equal to bms_no_output_of_prior_mesh_frames_flag.
2. The value of NoOutputOfPriorMeshFramesFlag derived for the decoder under test is applied for the HRD as follows:
   If NoOutputOfPriorMeshFramesFlag is equal to 1, all basemesh frame storage buffers in the DBMB are emptied without output of the basemesh frames they contain, and the DBMB fullness is set equal to 0.
   Otherwise (NoOutputOfPriorMeshFramesFlag is equal to 0), all basemesh frame storage buffers containing a basemesh frame that is marked as “not needed for output” and “unused for reference” are emptied (without output), and all non-empty basemesh frame storage buffers in the DBMB are emptied by repeatedly invoking the “bumping” process specified in H.12.5.2.4, and the DBMB fullness is set equal to 0.
   Otherwise (the current basemesh frame is not an IRAP basemesh frame with NoOutputBeforeRecoveryFlag equal to 1), all basemesh frame storage buffers containing a basemesh frame which are marked as “not needed for output” and “unused for reference” are emptied (without output). For each basemesh frame storage buffer that is emptied, the DBMB fullness is decremented by one. When one or more of the following conditions are true, the “bumping” process specified in H.12.5.2.4 is invoked repeatedly while further decrementing the DBMB fullness by one for each additional basemesh frame storage buffer that is emptied, until none of the following conditions are true:
   The number of basemesh frames in the DBMB that are marked as “needed for output” is greater than bmsps_max_num_reorder_frames.
   bmsps_max_latency_increase_plus1 is not equal to 0 and there is at least one basemesh frame in the DBMB that is marked as “needed for output” for which the associated variable MeshFrameLatencyCount is greater than or equal to MaxLatencyBaseMeshFrames.
   The number of basemesh frames in the DBMB is greater than or equal to bmsps_max_dec_mesh_frame_buffering_minus1+1.

### H.12.5.2.3 Additional Bumping

The processes specified in this subclause happen instantaneously when the last decoding unit of coded basemesh access unit n containing the current basemesh frame is removed from the CBMB.

When the current basemesh frame has MeshFrameOutputFlag equal to 1, for each basemesh frame in the DBMB that is marked as “needed for output” and follows the current basemesh frame in output order, the associated variable MeshFrameLatencyCount is set equal to MeshFrameL atencyCount+1.

The following applies:
If the current decoded basemesh frame has MeshFrameOutputFlag equal to 1, it is marked as “needed for output” and its associated variable MeshFrameLatencyCount is set equal to 0.
Otherwise (the current decoded basemesh frame has MeshFrameOutputFlag equal to 0), it is marked as “not needed for output”.
When one or more of the following conditions are true, the “bumping” process specified in H.12.5.2.4 is invoked repeatedly until none of the following conditions are true:
The number of basemesh frames in the DBMB that are marked as “needed for output” is greater than bmsps_max_num_reorder_frames.
bmsps_max_latency_increase_plus1 is not equal to 0 and there is at least one basemesh frame in the DBMB that is marked as “needed for output” for which the associated variable MeshFrameLatencyCount that is greater than or equal to MaxLatencyBaseMeshFrames.

### H.12.5.2.4 “Bumping” Process

The “bumping” process includes the following ordered steps:
1. The basemesh frame that is first for output is selected as the one having the smallest value of MeshFrmOrderCntVal of all basemesh frames in the DBMB marked as “needed for output”.
2. The basemesh frame is output, and the basemesh frame is marked as “not needed for output”.
3. When the basemesh frame storage buffer that included the basemesh frame that was output contains a basemesh frame marked as “unused for reference”, the basemesh frame storage buffer is emptied.

For any two basemesh frames meshFrmA and meshFrmB that belong to the same CBMS and are output by the “bumping process”, when meshFrmA is output earlier than meshFrmB, the value of MeshFrmOrderCntVal of meshFrmA is less than the value of MeshFrmOrderCntVal of meshFrmB.

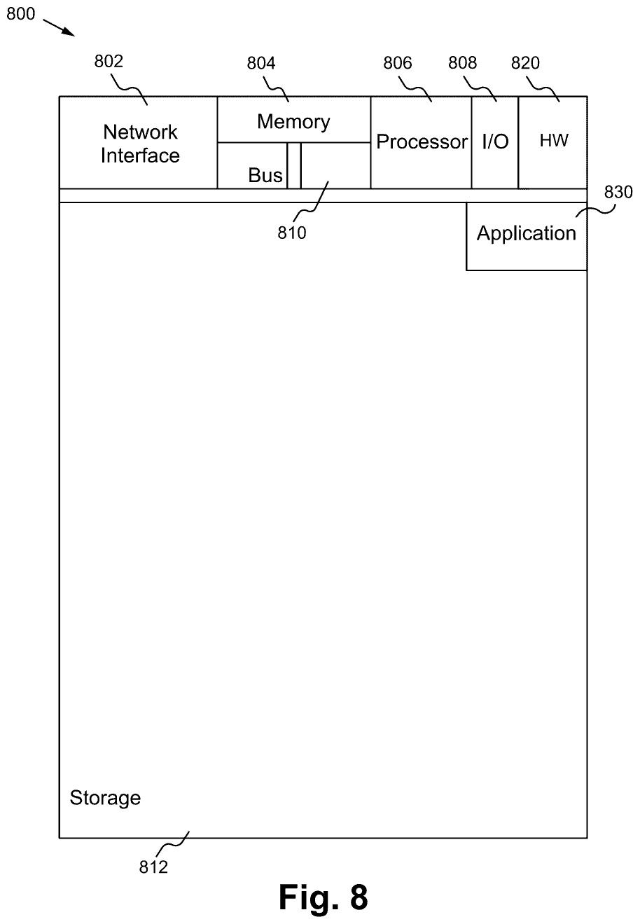

FIG. 8 shows a block diagram of an exemplary computing device configured to implement the basemesh decoder according to some embodiments. The computing device 800 is able to be used to acquire, store, compute, process, communicate and/or display information such as images and videos. The computing device 800 is able to implement any of the basemesh decoder aspects. In general, a hardware structure suitable for implementing the computing device 800 includes a network interface 802, a memory 804, a processor 806, I/O device(s) 808, a bus 810 and a storage device 812. The choice of processor is not critical as long as a suitable processor with sufficient speed is chosen. The memory 804 is able to be any conventional computer memory known in the art. The storage device 812 is able to include a hard drive, CDROM, CDRW, DVD, DVDRW, High Definition disc/drive, ultra-HD drive, flash memory card or any other storage device. The computing device 800 is able to include one or more network interfaces 802. An example of a network interface includes a network card connected to an Ethernet or other type of LAN. The I/O device(s) 808 are able to include one or more of the following: keyboard, mouse, monitor, screen, printer, modem, touchscreen, button interface and other devices. Basemesh decoder application(s) 830 used to implement the basemesh decoder are likely to be stored in the storage device 812 and memory 804 and processed as applications are typically processed. More or fewer components shown in FIG. 8 are able to be included in the computing device 800. In some embodiments, basemesh decoder hardware 820 is included. Although the computing device 800 in FIG. 8 includes applications 830 and hardware 820 for the basemesh decoder, the basemesh decoder is able to be implemented on a computing device in hardware, firmware, software or any combination thereof. For example, in some embodiments, the basemesh decoder applications 830 are programmed in a memory and executed using a processor. In another example, in some embodiments, the basemesh decoder hardware 820 is programmed hardware logic including gates specifically designed to implement the basemesh decoder.

In some embodiments, the basemesh decoder application(s) 830 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

To utilize the basemesh decoder described herein, a device is used to receive and decode content. The basemesh decoder is able to be implemented with user involvement or automatically without user involvement.

In operation, the basemesh decoder is able to be utilized as a single decoder, to facilitate the description and operation of HRD model for annex H. Moreover, the HRD operation in terms of both basemesh and the segmented submeshes is illustrated. Subsequently, the related syntax tables and structures as well as the semantics associated with basemesh SPS, VUI, buffering period, basemesh timing, and decoded unit information SEI messages are described and listed.

### Some Embodiments of Hypothetical Reference Decoding Operation for Basemesh Bitstreams

1. A method programmed in a non-transitory memory of a device comprising:
   receiving a basemesh bitstream;
   decoding, using a basemesh buffer, the basemesh bitstream into a mesh comprising vertex information and connectivity information.
2. The method of clause 1 further comprising:
   parsing the basemesh bitstream into a parsed basemesh bitstream;
   decoding the parsed basemesh bitstream into a decoded submesh which includes submesh data and a submesh header;
   extracting data from the submesh data;
   performing intra submesh processing;
   performing inter submesh processing; and
   performing skip submesh processing.
3. The method of clause 1 wherein the basemesh buffer is configured for storing the decoded submesh and additional mesh information.
4. The method of clause 3 wherein the additional mesh information comprises: duplicate vertex coordinate information;
   vertex neighbor count information; and
   vertex neighbor information.
5. The method of clause 1 wherein decoding the basemesh bitstream is implemented without utilizing internal buffering.
6. The method of clause 1 wherein the basemesh bitstream is divided into a plurality of submeshes which are decoded independently.
7. The method of clause 1 wherein a reference mesh of the basemesh bitstream and the mesh have a same number of attributes, connectivity and vertices.
8. An apparatus comprising:
   a non-transitory memory for storing an application, the application for:
      receiving a basemesh bitstream;
      decoding, using a basemesh buffer, the basemesh bitstream into a mesh comprising vertex information and connectivity information; and
   a processor coupled to the memory, the processor for processing the application.
9. The apparatus of clause 8 wherein the application is further configured for:
   parsing the basemesh bitstream into a parsed basemesh bitstream;
   decoding the parsed basemesh bitstream into a decoded submesh which includes submesh data and a submesh header;
   extracting data from the submesh data;
   performing intra submesh processing;
   performing inter submesh processing; and
   performing skip submesh processing.
10. The apparatus of clause 8 wherein the basemesh buffer is configured for storing the decoded submesh and additional mesh information.
11. The apparatus of clause 10 wherein the additional mesh information comprises: duplicate vertex coordinate information;
   vertex neighbor count information; and
   vertex neighbor information.
12. The apparatus of clause 8 wherein decoding the basemesh bitstream is implemented without utilizing internal buffering.
13. The apparatus of clause 8 wherein the basemesh bitstream is divided into a plurality of submeshes which are decoded independently.
14. The apparatus of clause 8 wherein a reference mesh of the basemesh bitstream and the mesh have a same number of attributes, connectivity and vertices.
15. A system comprising:
   an encoder configured for encoding a basemesh bitstream; and
   a decoder configured for:
      receiving the basemesh bitstream;
      decoding, using a basemesh buffer, the basemesh bitstream into a mesh comprising vertex information and connectivity information.
16. The system of clause 15 wherein the decoder is further configured for:
   parsing the basemesh bitstream into a parsed basemesh bitstream;
   decoding the parsed basemesh bitstream into a decoded submesh which includes submesh data and a submesh header;
   extracting data from the submesh data;
   performing intra submesh processing;
   performing inter submesh processing; and performing skip submesh processing.
17. The system of clause 15 wherein the basemesh buffer is configured for storing the decoded submesh and additional mesh information.
18. The system of clause 17 wherein the additional mesh information comprises: duplicate vertex coordinate information;
   vertex neighbor count information; and
   vertex neighbor information.
19. The system of clause 15 wherein decoding the basemesh bitstream is implemented without utilizing internal buffering.
20. The system of clause 15 wherein the basemesh bitstream is divided into a plurality of submeshes which are decoded independently.
21. The system of clause 15 wherein a reference mesh of the basemesh bitstream and the mesh have a same number of attributes, connectivity and vertices.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
receiving a basemesh bitstream;
decoding, using a basemesh buffer, the basemesh bitstream into a mesh comprising vertex information and connectivity information.

2. The method of claim 1 further comprising:
parsing the basemesh bitstream into a parsed basemesh bitstream;
decoding the parsed basemesh bitstream into a decoded submesh which includes submesh data and a submesh header;
extracting data from the submesh data;
performing intra submesh processing;
performing inter submesh processing; and
performing skip submesh processing.

3. The method of claim 1 wherein the basemesh buffer is configured for storing the decoded submesh and additional mesh information.

4. The method of claim 3 wherein the additional mesh information comprises:
duplicate vertex coordinate information;
vertex neighbor count information; and
vertex neighbor information.

5. The method of claim 1 wherein decoding the basemesh bitstream is implemented without utilizing internal buffering.

6. The method of claim 1 wherein the basemesh bitstream is divided into a plurality of submeshes which are decoded independently.

7. The method of claim 1 wherein a reference mesh of the basemesh bitstream and the mesh have a same number of attributes, connectivity and vertices.

8. An apparatus comprising:
a non-transitory memory for storing an application, the application for:
receiving a basemesh bitstream;
decoding, using a basemesh buffer, the basemesh bitstream into a mesh comprising vertex information and connectivity information; and
a processor coupled to the memory, the processor for processing the application.

9. The apparatus of claim 8 wherein the application is further configured for:
parsing the basemesh bitstream into a parsed basemesh bitstream;
decoding the parsed basemesh bitstream into a decoded submesh which includes submesh data and a submesh header;
extracting data from the submesh data;
performing intra submesh processing;
performing inter submesh processing; and
performing skip submesh processing.

10. The apparatus of claim 8 wherein the basemesh buffer is configured for storing the decoded submesh and additional mesh information.

11. The apparatus of claim 10 wherein the additional mesh information comprises:
duplicate vertex coordinate information;
vertex neighbor count information; and
vertex neighbor information.

12. The apparatus of claim 8 wherein decoding the basemesh bitstream is implemented without utilizing internal buffering.

13. The apparatus of claim 8 wherein the basemesh bitstream is divided into a plurality of submeshes which are decoded independently.

14. The apparatus of claim 8 wherein a reference mesh of the basemesh bitstream and the mesh have a same number of attributes, connectivity and vertices.

15. A system comprising:
an encoder configured for encoding a basemesh bitstream; and
a decoder configured for:
receiving the basemesh bitstream;
decoding, using a basemesh buffer, the basemesh bitstream into a mesh comprising vertex information and connectivity information.

16. The system of claim 15 wherein the decoder is further configured for:
parsing the basemesh bitstream into a parsed basemesh bitstream;
decoding the parsed basemesh bitstream into a decoded submesh which includes submesh data and a submesh header;
extracting data from the submesh data;
performing intra submesh processing;
performing inter submesh processing; and
performing skip submesh processing.

17. The system of claim 15 wherein the basemesh buffer is configured for storing the decoded submesh and additional mesh information.

18. The system of claim 17 wherein the additional mesh information comprises:
duplicate vertex coordinate information;
vertex neighbor count information; and
vertex neighbor information.

19. The system of claim 15 wherein decoding the basemesh bitstream is implemented without utilizing internal buffering.

20. The system of claim 15 wherein the basemesh bitstream is divided into a plurality of submeshes which are decoded independently.

21. The system of claim 15 wherein a reference mesh of the basemesh bitstream and the mesh have a same number of attributes, connectivity and vertices.
